(19) United States
(12) Patent Application Publication
(10) Pub. No.: US 2004/0209224 A1
(43) Pub. Date: Oct. 21, 2004

(54) Cervical retraction rubber dam clamps and retaining devices for general field isolation and modified conventional rubber dam isolation

(76) Inventor: John Heasley, Iowa City, IA (US)

Correspondence Address: DAVIS, BROWN, KOEHN, SHORS & ROBERTS, P.C., THE FINANCIAL CENTER, 666 WALNUT STREET, SUITE 2500, DES MOINES, IA, 50309-3993, US

(21) Appl. No.: 10/413,844

(22) Filed: Apr. 15, 2003

(51) Int. Cl. A61C 5/12

(52) U.S. Cl. 433/139

(57) ABSTRACT

The invention relates to a series of rubber dam retaining devices which use cervically directed forces to cervically retract and retain a rubber dam below the gum line in the mouth of a patient during dental treatment. The series includes two classifications of cervical retraction and retaining devices; intra-arch clamping devices which utilize inwardly directed reciprocal force to attach directly to a tooth for retention and inter-arch retaining devices which utilize the reciprocal forces of the upper and lower alveolar arches to retract and retain a rubber dam in the mouth of a patient during treatment. The invention has implications for general field isolation in dentistry, conventional isolation, and a hybrid type of isolation which involves both conventional isolation and general field isolation simultaneously.

### BACKGROUND OF THE INVENTION

1. Field of the Invention

The invention relates generally to rubber dam devices used for retaining and retracting a rubber dam membrane during a dental procedure, and more particularly to rubber dam clamps and retaining devices used for the purpose of retracting a rubber dam below the gum line in a process of general field isolation. The disclosure also has implications for retracting and retaining a conventional isolation rubber dam and for hybrid isolation, which is a combination of conventionally isolated teeth with some selected teeth exposed with their associated gingival tissues for subgingival isolation.

2. Background

The original rubber dam was invented in 1864 by Dr. Sanford C. Barnum, of New York and was recognized and accepted the first really effective isolation modality which fulfilled the dentists' need to work in a dry field. The day that Dr. Barnum invented the first rubber dam, he also invented the first rubber dam retaining device, a little rubber ring that went down over the neck of the tooth. Since then rubber dam retention devices have generally evolved into what are commonly called rubber dam clamps. These clamps, which come in all sizes and shapes, are generally made of stainless steel, but recently, plastic and composite clamps have appeared on the market with varying levels of acceptance by the dental community. The clamp's function, when used with the conventional technique of rubber dam usage, is generally to retain the rubber dam in the mouth and to resist the internal tensile forces generated within the dam as it is stretched over a framework external to the mouth. The conventional rubber dam technique principally isolates just the clinical crowns of teeth, thereby limiting instrumentation with the rubber dam in place to procedures which are principally supra-gingival i.e. procedures instrumenting the hard structures of the teeth above the gum line.

Although most clinicians have largely been satisfied with isolation limited to the clinical crowns of the teeth, recent attempts have been made to extend the reach of rubber dam usage to subgingival areas. The most commonly used approach has been to cut the interseptal rubber in between the teeth, thereby opening this area to instrumentation for deep interproximal removal of tooth structure. Another technique that has appeared on the scene is called the slit-dam technique of field isolation. With this approach, first individual holes are punched in conventional rubber dam material, then, a scissors is employed to cut between the holes in order to create a slit in the rubber dam where field isolation is desired. The rubber dam is placed in the mouth are teeth are isolated as a group, instead of individually as in the conventional technique. The technique makes the rubber dam easier to apply, because interseptal rubber does not have to be flossed through every contact point in order to seat the dam. The objective of allowing the clinician to instrument subgingivally, however, has met with compromised or mixed success with the technique, since the rubber dam is retained at the level of the gum line, since the stretched rubber snaps into a linear plane at this level. Since conventional rubber dam clamps lack a means of retracting the rubber dam below the gum line, the slit-dam technique is largely ineffective for subgingival instrumentation with these devices without the use of specialized retraction devices to aid in the exposure of both the teeth and soft tissues simultaneously.

The devices of this disclosure apply cervically directed forces, whether to retract a rubber dam membrane from a specific reference point, such as the gum line as in the case of general field isolation clamps, or alternatively to retract the rubber dam in a generally cervical direction from a reference point which is on an alveolar arch opposing the arch which is to be isolated. The clamps which clamp onto a tooth in a single arch are referred to as intra-arch retaining devices, while the devices which interact with the both opposing arches simultaneously are referred to as inter-arch retaining devices.

### PRIOR ART

The prior art of rubber dam clamps as retaining devices is virtually limited to retention of the rubber dam at the level of the gum line, since conventional rubber dam technique isolates just the clinical crowns of the teeth. Since the slit-dam technique is relatively new, the prior art of field isolation retraction devices is sparse, if not bereft of instruments and devices which may aid in the improvement of the technique of general field isolation. Recently, a couple of new devices has appeared in the literature as attempts to extend the range of isolation with the use of the rubber dam, but both devices have similar design deficiencies which limit their effectiveness in subgingival instrumentation. The two devices are U.S. Pat. No. 5,503,556, Extended Dental Clamp, by Leonard and Crane, and also a Canadian product called Bond Buddy.

Patent '556 describes a device which attempts to isolate a tooth with a clinical crown that is so badly broken down that it cannot be isolated with the conventional rubber dam technique. This disclosure focuses narrowly on “being capable of isolating a tooth which cannot be clamped itself” and makes no mention of exposing both the teeth and associated soft tissues in order to instrument subgingivally to perform prosthetic procedures. Bond Buddy, a Canadian product for which no issued patent or patent application may be found, is a plastic device which is not integrally connected to a rubber dam clamp but is used with a conventional clamp in a manner which is identical to the device described in the '556 patent. Since each of these devices is identical in the way in which they retract a rubber dam membrane, a description of one is comparable to the other. Simply stated, the body and extensions of each device is in a coplanar relationship with the clamping mechanism which attaches the device to the tooth at the gum line. This limits the retraction of the rubber dam membrane to a plane coincidental to the gum line, preventing effective exposure of the gingival tissues (the gums) in addition to the clinical crown of a tooth. The claims of the patent and the discussion are explicit of the intent of the device to be designed to access a tooth only. Claim 1: “. . . a clamp for clamping a tooth and for supporting a flexible sheet for isolating a second tooth . . . , wherein the second tooth cannot be desireably clamped . . . with jaw extensions . . . being substantially coplanar with said jaws . . . ”. Claim 2 is equally explicit in describing the design of the clamp; “The clamp of claim 1 wherein the jaw extensions are substantially coplanar with the jaws”. There is no reference in the discussion of an intent to expose gingival tissues to facilitate subgingival instrumentation. This coplanar relationship of the retractive element to the clasping mechanism is fixed in place in the '556 design. Bond Buddy, not integrally attached to a clamping mechanism, is used with a conventional rubber dam clamp and fails to incorporate any intentional element in its design which would retract the dam in a cervical direction. Furthermore, both devices retract a rubber dam membrane laterally away from the teeth and the alveolar arch in an ‘all or none’ fashion, thereby creating open gaps which allow saliva and fluids to percolate through the operating field and small devices and particulates to fall into the patient's oral cavity beneath the membrane.

In order to understand the design differences between the prior art devices and the cervical retraction clamps and devices of this disclosure, the following breakdown is provided: for the purpose of analysis, the vector form of retraction of the rubber dam membrane with respect to the alveolar arch may be broken down into “X” and “Y” vector components. A retractive force in the “X” direction is defined as away from the tissues of the alveolar arch, and a retractive force in a “Y” direction is in a cervical direction from the clinical crown in the direction of the end of the root. A force in the X direction pulls the rubber dam away from the tissues and subsequently leaves a gap open to the percolation of fluids, which is an undesirable design component, while a force which eliminates or minimizes the X component while retracting primarily in the cervical or Y direction, is generally considered to be desirable. Each of the prior art devices is essentially coplanar with their clamping action, and retract the edges of the rubber dam membrane laterally, which means that they retract the rubber dam membrane in a plane which is largely flush with the gum line and in a manner which creates open gaps. In each, there is no systematically designed Y component of retraction. The Extended Dental Clamp, of U.S. Pat. No. 5,503,556, besides leaving the extended wings of the clamp at the level of the gum line, places the steel of the extensions of the clamp in such close proximity to the margins of the tooth to be prepared, that the clinician does not have adequate access with the cutting bur to prepare the margins of a crown, without nicking the stainless steel of the wings of the clamp in the process. Both the Extended Dental Clamp and Bond Buddy retract the edges of the rubber dam membrane in an ‘all-or-none’ fashion, away from the tissues of the alveolar arch, thus leaving open gaps for the percolation of fluids through the membrane.

The field isolation clamps and devices described herein, whether used with the slit-dam technique or with specialized general field isolation rubber dam membranes, minimize or eliminate the “X” vector component of retraction, while effectively retracting primarily in the “Y” component direction. In addition, these field isolation clamps and devices allow for variable retraction of the rubber dam membrane, not at its edges, but by frictional or other forces in interaction with the membrane itself, by the inclusion of nibs or tabs which grab the stretched rubber dam membrane material. This allows the edges of the rubber dam membrane to be variably adjusted such that they come into contact with the tissues to be isolated in order to seal the tissue-dam interface.

Although most of the examples of alternative embodiments show clamps with arm extensions which allow for the isolation of whole groups of teeth and portions of the alveolar arch, embodiments of clamps without extended arms, but maintaining the “Y” vector component of retraction, where the retracting force of an element of the clamp is located in a plane cervical to the clamping mechanism of attachment to the tooth at the gum line, with the intent of retracting, for example, a general field isolation rubber dam with or without integral operative inserts, is also within the spirit and scope of this disclosure.

The 212 series of rubber dam clamps is well known in the prior art as clamping devices which retract the gum in a manner in which a greater portion of the root of the tooth is showing below the natural height of the free marginal gingival (the gum line) in order to remove diseased tooth structure on the root surface not visible and accessible without a retracting clamp. These clamps may have evolved from a clamping device described in U.S. Pat. No. 2,706,333, issued Apr. 19. 1955 to A. G. Schultz, entitled Rubber Dam Clamps. The clamping device described in this patent and also all of the contemporary 212 series clamps, clamp onto a single tooth to allow the dentist to remove diseased carious tooth structure specifically on the root of that tooth. The device described in '333 as well as the contemporary 212 clamp is used with a rubber dam that is applied in the conventional manner with a single hole punched in the dam to isolate an individual tooth with root caries extending below the gum line. The clamp described in '333 isolates one tooth at a time and makes no mention of isolating any teeth other than the one being clamped. FIG. 5 of '333 clearly shows the edges of the rubber dam material extending to the tooth at the level of the clasping mechanism, in complete contrast to the cervical retraction clamps of the current disclosure, where the rubber dam is retracted below the clasping mechanism so as to expose not only teeth, but the surrounding soft tissues, so that the clinician may instrument subgingivally and perform prosthetic procedures. Furthermore, the clamp of '333, as well as the contemporary 212 clamps, lacks any mechanism on the clamp to further retract the rubber dam cervically below the clasping mechanism for subgingival instrumentation. Simply stated, the clamp retracts the gum to expose the root, but does not retract the rubber dam membrane to expose the gums.

U.S. Pat. No. 1,785,624, issued Dec. 16, 1930 to Ludwig Haller, of Stuttgart, Germany, entitled Tooth Clamp, describes a clamp comprising a bow and two parallel arms extending on the inner and outer side along a row of teeth, the arms said to be adapted to hold an “elastic tying-off element” of rubber thread for “pressing back the gum between two tooth crowns”. When the clamp was clamped onto a tooth, it placed the lower arms below the crowns of the teeth, but the patent does not mention having any purpose what-so-ever to retracting a rubber dam. Instead, it talks of “tying back of the gum between two tooth crowns and the tying off of the bleeding points” with the aid of a “rubber thread”. The clamp was said to be designed to “protect the gum of a tooth” . . . “against injury caused by instruments of a metal clamp clamped onto the neck of a tooth” . . . “in the neighborhood where an operation is to be carried out”. This clamp has nothing to do with retraction of a rubber dam or general field isolation, but apparently is an attempt to create a device to induce hemostasis around a tooth.

U.S. Pat. No. 3,396,468, issued Aug. 13, 1968 to D. G. Dayhoff, entitled Dental Appliance, describes a device which simultaneously removes fluids from a patient's mouth and which can be quickly and easily placed in a patient's mouth. The device consists of hollow tubes with orifices through which saliva and fluids are suctioned when the device is attached to a vacuum device to draw fluids through the tubes. The tubings generally lie on the buccal and lingual sides of the patient's maxillary and mandibular arches and bridge the space between the two arches. The device has ‘button-like’ protrusions for attaching a small intra-oral elastic sheet which functions primarily as a lingual shield which blocks the tongue and oral cavity on the lingual side of the alveolar arch. Openings through which individual teeth may be brought through the sheet in the conventional manner are provided. There is no mention of any membrane being stretched to a framework outside of the mouth as in the true prior art rubber dam technique. Inherent within the design is the loss of retraction of the lips and the cheeks, and therefore the loss of significant access to the operative site. The incomplete isolation allows fluids to percolate between the patient's oral cavity and the operative site. While the device does utilize the reciprocal forces of the opposing arches for retention, it does not do so in the service of a true rubber dam membrane which is stretched over a framework external to the patient's mouth and which forms a contiguous barrier between the patient's oral cavity and the operative site. This device should be classified as a limited intra-oral barrier device and saliva ejector, not as a retaining device for a true rubber dam.

U.S. Pat. No. 4,600,387 issued Jul. 15, 1986 to Robert Ross, entitled Rubber Dam Frame for Dental Work consists of a two-member elliptical radiolucent plastic frame having arcuate openings matching the upper and lower teeth of a patient and an opening adjacent to the throat area. A rubber dam sheet is said to be disposed between the two frame members so as to cover the openings and to be snapped together with the rubber dam membrane so interposed to form a “dam assembly”. The dam sheet is said to be able to be cut or punched to isolate one or more teeth with the uncut portions protecting the patient's throat and mouth. Relieved areas 16 and 26 centrally located between the two halves of the elliptical pattern are provided “to form a self-hinge” to allow the two halves of the assembly to fold in a simple hinge-axis manner. This is a major design flaw in the concept of this device. If the upper and lower alveolar arches of the maxilla and mandible pivoted about a single axis located approximately one centimeter behind the last tooth in the mouth, this design would be feasible. In human anatomy, however, the maxillary and mandibular teeth disocclude in an almost parallel manner (actually slightly arcuate) manner, since the temperomandibular joint is located approximately 4″ to 6″ away from the occluding surfaces of the alveolar arches. Since the teeth disocclude in this manner, the design of a device to accommodate a rubber dam must take into account the dimension of the inter-occlusal distance of the opened mouth. A successful inter-arch appliance, therefore, must incorporate an inter-occlusal element which accommodates to the distance between the separated arch segments when the patient's mouth is open. Inter-occlusal distance of the opened mouth can vary greatly, depending on how large a patient's anatomical features are and how wide the degree of opening of the patient's mouth. While inter-occlusal dimensions in the posterior of the mouth 1½ inches or more, the inter-occlusal dimension toward the front of the mouth may be as great as 2½ to 3 inches. In general, the inter-occlusal distance of the opened mouth increases in a manner which is directly proportional from posterior to anterior in the oral cavity. The Ross patent describes a device which folds along a single hinge axis. A properly designed intra-oral retention device is one which either folds along two separate axes separated by a distance accommodating to the anticipated inter-occlusal distance, or if casually flexed in a generally rounded “U” shape form without rectilinear bends, separates the functional reciprocal arch components by the same distance of the anticipated inter-occlusal height of dimension of placement of the device in the mouth during application. To be maximally precise, the two hinge axes should be located at the junction of the bend between the reciprocal transverse arches and the labial and lingual bows of each contacting arch.

Another design flaw of the Ross retention device is that it appears to be designed for whole arch isolation, which would carry the flat rubber dam membrane material so far back into the oral cavity that it would gag the patient during use. A whole-arch design for a rubber dam or for a device which facilitates whole arch isolation needs to have an inner concave form of membrane which would not compromise the intra-alveolar space where the patient's tongue is located.

### SUMMARY OF THE INVENTION

All clamps and devices in the series have design components which predominantly have a desirable “Y” component of retraction of the rubber dam membrane in a cervical direction, parallel to the long axes of the teeth and in a direction toward the roots of the teeth. In addition, the devices of this disclosure minimize or eliminate an undesirable “X” component of retraction of the rubber dam membrane laterally away from the alveolar arch of tissues, thereby minimizing or preventing gaps or leaks to compromise isolation of the operating site.

The invention consists of a series of rubber dam clamps and isolation devices which retract and retain a rubber dam in a manner which facilitates general field isolation, conventional rubber dam isolation, or a hybrid form of isolation which utilizes features of both field isolation and conventional isolation. The series of devices consists of a series of intra-arch clamps used alone or in conjunction with malleable, resilient and deformable, or rigid elements to achieve retraction of an operative field or alternatively inter-arch cervical retraction devices are described. All devices use predominantly cervically directed forces to retract or retain a rubber dam membrane during dental treatment. FIG. 1 shows an intra-arch rubber dam clamp utilizing cervically directed forces (arrows show the direction of cervical retraction, which is in the direction toward the end of the root of a tooth) as a means to cervically retract a rubber dam membrane below the gum line. FIG. 10a shows an inter-arch rubber dam retaining device utilizing reciprocal inter-arch forces to retract a rubber dam membrane in a cervical direction to achieve the same result (both the upper and lower arrows show reciprocal cervically directed forces. Due to a 180 degree difference in the orientation of teeth in the upper and lower alveolar arches, all reciprocally directed forces are toward the ends of the roots. While both FIGS. 1 and FIG. 10a show the rubber dam membranes exposing the teeth and their associated soft tissues in a general field isolation application, these devices also have significance for conventional isolation of the rubber dam in dentistry. The intra-arch clamping devices are confined to action within a given single arch, while inter-arch retention and retracting devices use reciprocal inter-arch forces of both the upper and lower arches to retain and retract rubber dams.

### BRIEF DESCRIPTION OF THE DRAWINGS

FIG. 1a is an end view of a cervical retraction rubber dam clamp retracting a rubber dam in a cervical direction below the gum line to expose both the teeth and the associated soft tissues. Arrows show the direction of cervical retraction forces (toward the end of the root of the tooth).

FIG. 1b is an isometric view of an extended cervical retraction rubber dam clamp with nibs retracting a rubber dam below the gum line to expose a number of teeth and their associated soft tissues simultaneously.

FIG. 1c is a side view of an extended cervical retraction rubber dam clamp with nibs retracting a rubber dam below the gum line to expose a number of teeth and their associated soft tissues simultaneously.

FIG. 1d is a top view of an extended cervical retraction rubber dam clamp with nibs retracting a rubber dam below the gum line to expose a number of teeth and their associated soft tissues simultaneously.

FIG. 2a shows an extended cervical retraction rubber dam clamp retaining a rubber dam in a forward position, while a clinician applies another cervical retraction rubber dam clamp in a reverse orientation.

FIG. 2b shows the completed application of forward and reverse cervical retraction rubber dam clamps acting together to form a perimeter around an operative site.

FIG. 3a is a side view of a circumferential cervical retraction rubber dam clamp with nibs retracting a rubber dam below the gum line to expose a number of teeth and their associated soft tissues simultaneously.

FIG. 3b is a top view of a circumferential cervical retraction rubber dam clamp with nibs retracting a rubber dam below the gum line to expose a number of teeth and their associated soft tissues simultaneously.

FIG. 4a is an isometric view of left and right anterior cervical retraction rubber dam clamps with nibs engaging an upper arch of teeth (rubber dam not shown).

FIG. 4b is an isometric view of left and right anterior cervical retraction rubber dam clamps with nibs retaining and retracting a general field isolation rubber dam membrane for anterior segment isolation.

FIG. 4c is a front view of left and right anterior cervical retraction rubber dam clamps with nibs retaining and retracting a general field isolation rubber dam for anterior segment isolation.

FIG. 4d is an isometric view of left and right anterior cervical retraction rubber dam clamps with nibs retaining and retracting a general field isolation rubber dam for anterior segment isolation during dental treatment (completed rubber dam application).

FIG. 5a is an isometric view of an anterior retraction labial bow connected to left and right cervical retraction rubber dam clamps with connectors to complement the labial bow element (rubber dam not shown).

FIG. 5b is a top view of an anterior labial bow retraction element connected to left and right cervical retraction rubber dam clamps (rubber dam not shown).

FIG. 6a is a posterior malleable element and a cervical retraction rubber dam clamp designed to attach to the malleable element.

FIG. 6b shows a clinician bending the malleable element with finger pressure.

FIG. 6c shows a clinician placing the clamp and malleable retraction element into position with a rubber dam forceps.

FIG. 6d shows the clamp and retraction element in place over a quadrant in a reverse orientation, retracting the rubber dam in a clinical circumstance where posterior rubber dam clamps cannot be applied to badly broken down teeth.

FIG. 6e shows the completed rubber dam application with the cervical retraction clamp and the malleable element in a reverse orientation.

FIG. 6f shows the same clamp and malleable retraction element in a forward orientation on an arch with intact teeth retracting a field isolation rubber dam below the gum line to expose both the teeth and the soft tissues.

FIG. 7 is an isometric view of a posterior circumferential element with a circumferential mesh for the attachment of barrier material connected to a cervical retraction rubber dam clamp.

FIG. 8a is a cross sectional view of a cervical retraction rubber dam clamp which attaches directly to projections from an operative insert of a modified field isolation rubber dam membrane. The operative insert and the dam, directly connected to the clamp, becomes an extended element of the clamp.

FIG. 8b shows a clinician utilizing a rubber dam forceps to prepare to apply the clamp and attached rubber dam in an application.

FIG. 9a is an isometric view of a cervical retraction clamp which attaches to a tooth with broad based adhesive retention pads as an alternative type of retention of the clamps.

FIG. 9b is an isometric view of a broad-based retention pad without an adhesive integrally applied which either relies on improved frictional forces for stabilization or alternatively may utilize a manually applied adhesive.

FIG. 9c is an isometric view of a broad-based retention pad with an integrally applied pressure-sensitive adhesive and a release liner partially peeled back to show the adhesive surface.

FIG. 10a is a cross-sectional view of a unilateral reciprocal inter-arch retaining device applying cervically directed forces simultaneously to both the upper and lower alveolar arches to retain and retract a rubber dam membrane in a manner which exposes a number of teeth and associated soft tissues in the lower posterior segment of the mandibular arch. Arrows show the direction of reciprocal cervical retraction forces (toward the end of the root of the tooth).

FIG. 10b is an isometric view of a unilateral reciprocal inter-arch retaining device applying cervically directed forces to the upper and lower alveolar arches to retain and retract a rubber dam membrane in a manner which exposes a number of teeth and associated soft tissues in the mandibular arch.

FIG. 10c shows a unilateral resilient inter-arch retraction element being bent with bending pliers.

FIG. 10d shows the unilateral resilient inter-arch retaining device bent into elements of reciprocal facial bows, lingual bows, and transverse arches connected by inter-occlusal connecting elements.

FIG. 10e shows the unilateral resilient inter-arch retaining device retracting a field isolation rubber dam to expose both the teeth and the soft tissues.

FIG. 10f shows the completed application; the rubber dam retracted and retained wholly with the unilateral resilient inter-arch retraction device. The rubber dam membrane is stretched to a framework external to the mouth which is a separate device.

FIG. 10g shows a unilateral inter-arch retraction device which may either be a resilient, malleable, or rigid material supplemented by the use of upper and lower rubber dam clamps attached anteriorly to the retraction device.

FIG. 10h shows the completed rubber dam application of a unilateral inter-arch retraction device which is supplemented by rubber dam clamps. The rubber dam membrane is stretched to a framework outside of the mouth which is a separate device.

FIG. 11a is an isometric view of a bilateral resilient inter-arch retaining device which isolates teeth simultaneously on both sides of the midline, such as an anterior segment or anterior half arch. Rubber dam attachment nibs radiate outwardly.

FIG. 11b shows the bilateral inter-arch retaining device isolating anterior teeth bilaterally in a completed rubber dam application. The rubber dam is stretched to an external rubber dam frame which is a separate device.

FIG. 12a shows a resilient inter-arch retaining device integrally connected to an external rubber dam frame with rubber dam attachment nibs radiating outwardly from the resilient frame.

FIG. 12b shows a rubber dam membrane attached to the inter-arch retaining device with an integrally attached frame in a completed rubber dam application isolating a lower anterior segment of teeth.

FIG. 13a is an isometric view of a resilient unilateral inter-arch rubber dam retaining device with an integral frame attached.

FIG. 13b is an isometric view of the resilient unilateral inter-arch rubber dam retaining device with a rubber dam membrane stretched over the retaining device and the dam and device in a completed application isolating the mandibular left quadrant of a patient during dental treatment.

### DETAILED DESCRIPTION OF THE PREFERRED EMBODIMENTS

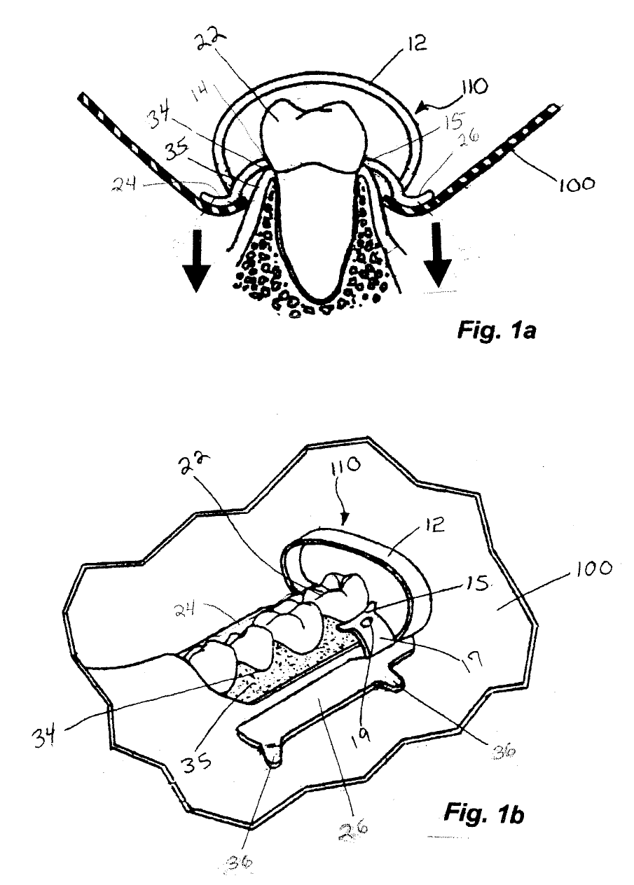

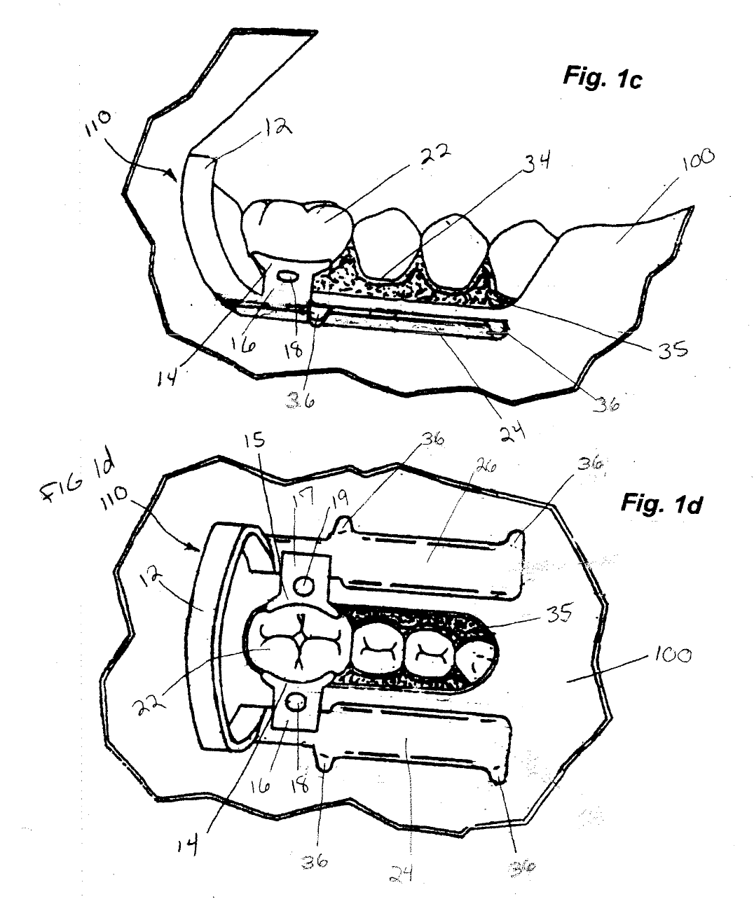

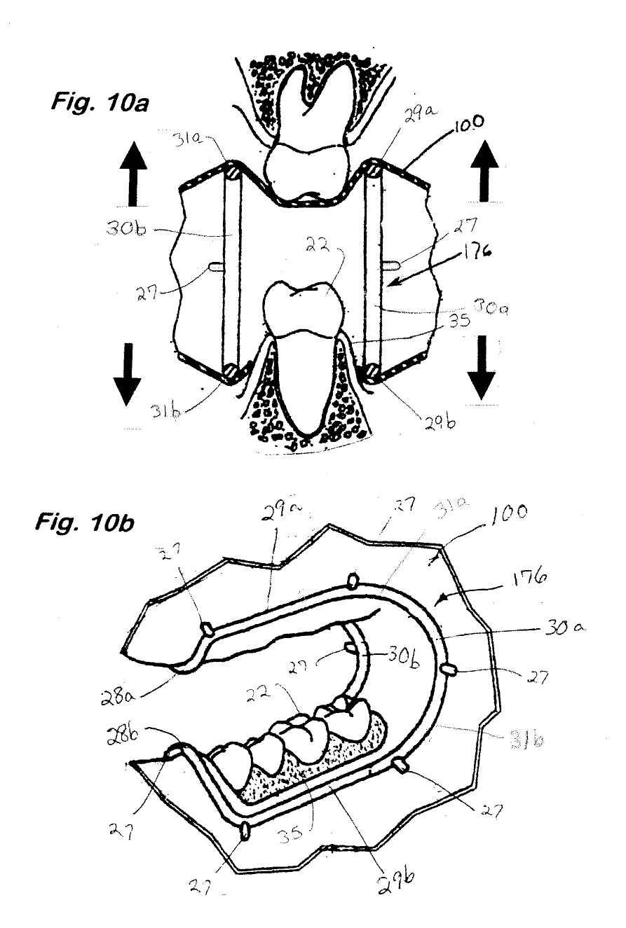

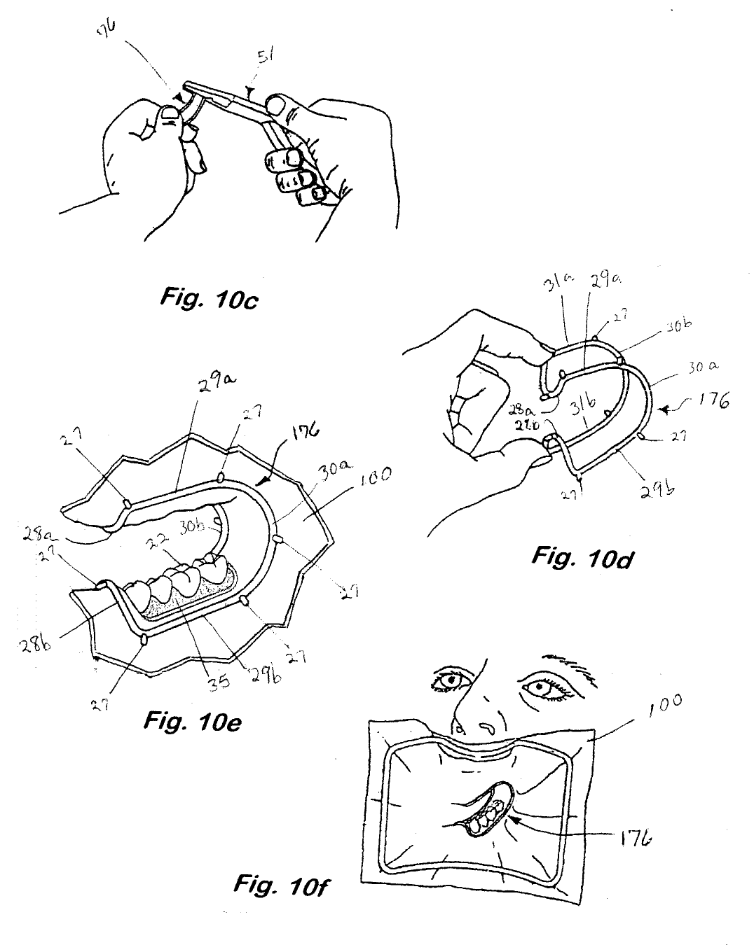

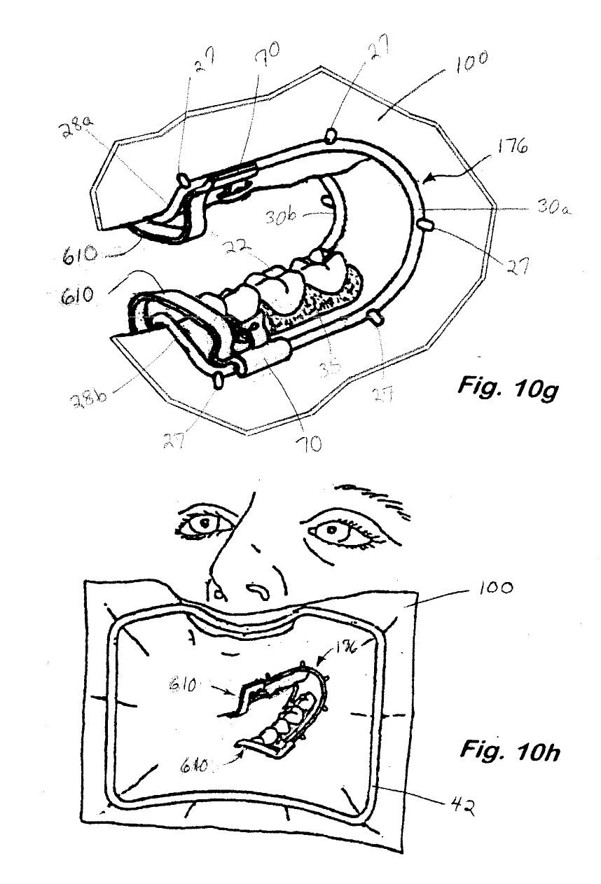

The isolation clamps and devices described herein, all have a component of retracting the rubber dam membrane in a cervical direction to expose the alveolar arch. Two general forms of devices are described; clamps which attach to a single tooth and act wholly within a single arch or reciprocal inter-arch retaining devices which span both arches to accomplish the same purpose by utilizing the reciprocal forces of the opposing arches. For the sake of organization of the discussion of these devices, all devices from FIG. 1 through FIGS. 9c describe the intra-arch devices, while FIGS. 10a through FIGS. 12b disclose the inter-arch devices. FIG. 1 is exemplary of a cross-section of a typical intra-arch cervical retraction clamping device, which retracts the rubber dam membrane cervically from the gum line for general field isolation. FIG. 10a is a cross-section of a typical inter-arch retaining device which utilizes reciprocal cervically directed inter-arch forces to retract and retain a rubber dam in a cervical direction. The intra-arch discussion precedes the inter-arch disclosure.

Intra-Arch Cervical Retraction Devices

Cervical Retraction Rubber Dam Clamps Without Added Elements

Field isolation rubber dam clamps used alone without any added elements all have the required design elements of minimizing lateral retraction of the rubber dam membrane while retracting the rubber dam membrane primarily in a cervical direction. These field isolation rubber dam clamps may be designed for anterior retraction purposes or for posterior retraction of field isolation rubber dams. They may be designed for enhancement of the slit-dam technique of field isolation, or they may be designed to be used with specialized field isolation rubber dams. They may be designed to retrain the rubber dam by frictional interaction with the rubber dam membrane, or they may be designed with retention ‘nibs’ or ‘tabs’ which grab stretched the. rubber dam membrane directly. They may be made of stainless steel, various metal alloys, metals, or plastics/composites for repeated use or they may be made disposable use. Although most of the applications of the clamps in the drawings provided are used in a forward direction, they may be equally applied in a reverse orientation.

Posterior Field Isolation Clamps Without Extended Elements:

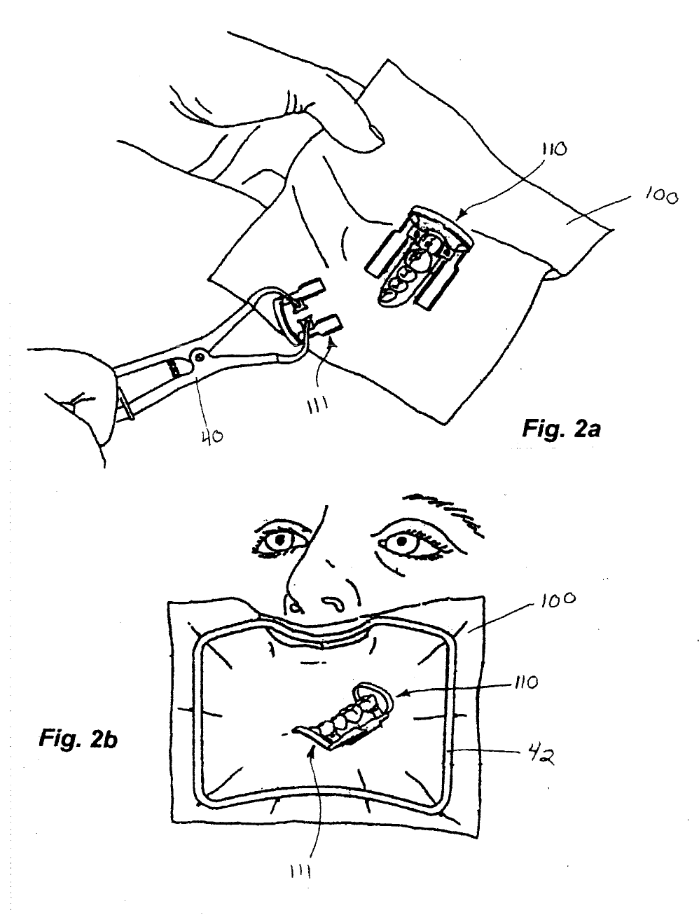

FIG. 1a, is an end view of a posterior open ended field isolation clamp, 110, applied to a tooth, 22, and retracting a rubber dam membrane, 100, cervical to the gum line, 34, allowing not only the clinical crowns of the teeth, 22, but the surrounding soft tissues (gums), 35, to be brought into the operative site for the dental procedure. As shown in FIGS. 1a, 1b, 1c, and 1d, the reciprocal clasps, 14, 15 of the clamp act as anchors to retain the dam in the mouth of a patient by transmitting reciprocal forces from the flexed transverse arch spring member, 12. Within the arched connecting members of the clasps, 16, 17, are forceps engaging holes, 18, 19 which allow a clinician to insert a forceps reciprocally into the clamp, 110, in order to spread the clamp by flexing the transverse arch spring member, 12. The overall body of the posterior field isolation rubber dam is designed at a more cervical level than the clasping mechanisms 14, 15 of the clamp with the retraction arm extensions, 24, 26, retracting the rubber dam cervically below the gum line 34. This allows both the dentist to instrument subgingivally (operate below the gum line) as required in prosthetic procedures. Four rubber dam retention nibs, 36 project from the retraction arm extensions, 24, 26, to allow for variable attachment of the rubber dam membrane to the clamp, thereby controlling the membrane laterally in contact with the alveolar arch. FIGS. 2a and 2b show that open ended posterior field isolation clamps may be applied in a forward direction or in a reverse orientation. FIG. 2a shows a field isolation clamp, 110, already applied to an application in a forward direction, with a clinician applying a smaller version of the same clamp 111, in a reverse orientation with a rubber dam forceps, 40. FIG. 2b shows the completed application, with the forward clamp, 110, and the clamp placed in reverse orientation, 111, together forming a circumferential perimeter to an operative site while retracting a rubber dam membrane, 100. The rubber dam membrane is stretched over a frame, 42, external to the patient's mouth.

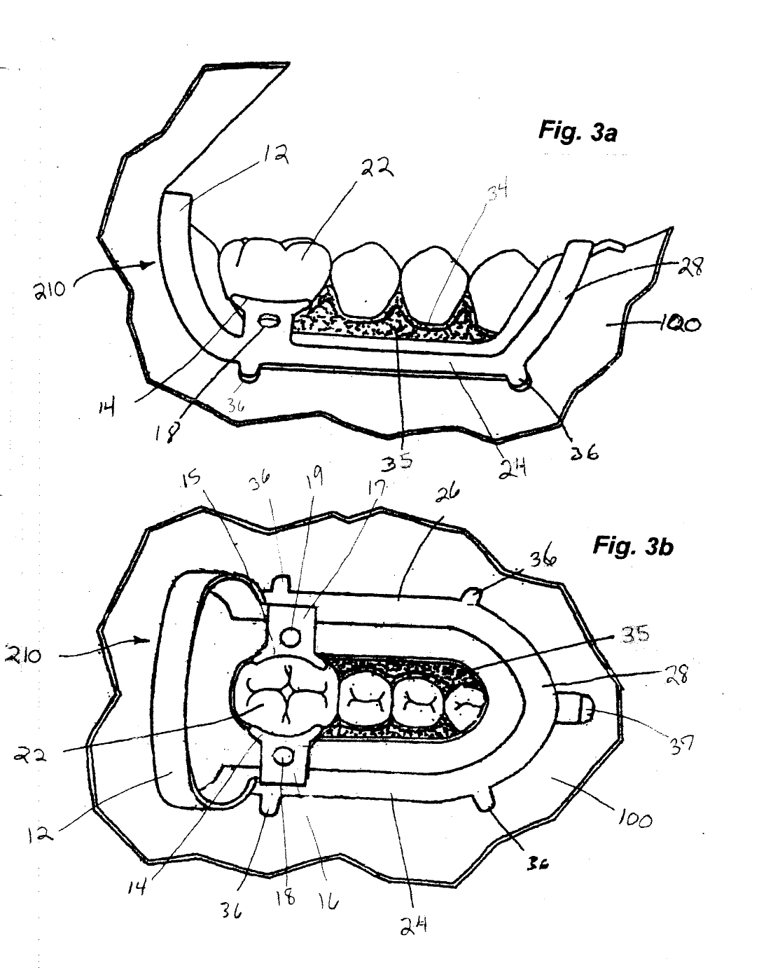

FIGS. 3a and 3b illustrate a posterior circumferential cervical retraction rubber dam clamp, 210 without extended elements, applied to a tooth, 22, which completely encircles the perimeter of an operative site. The body of this clamp is composed of four basic elements. Similar to the open ended clamp, there is a posterior transverse spring element, 12, a facial bow, 26, (also called a buccal bow in the posterior), and a lingual bow, 24. Unlike the open ended clamp, however, there is an anterior transverse arch, 28. Located at four positions around the periphery of the clamp are rubber dam attachment nibs, 36, and located on the crest of the anterior transverse arch is a rubber dam retraction tab, 37. Immediately anterior to the posterior transverse arch, 12, are the reciprocal opposing clasps, 14, 15, which engage the lingual and buccal surface of a tooth under tension applied by the flexed transverse spring arch member 12. The clasps, 14, 15, are mounted respectively on arched connecting members, 16, 17, connecting the clasps to the body of the clamp. On each of the arched connecting members, is located a forceps engaging hole 18, 19 to allow a forceps to reciprocally spread the clasps 14,15 to attach the clamp to the tooth.

Anterior Field Isolation Clamps Without Extended Elements:

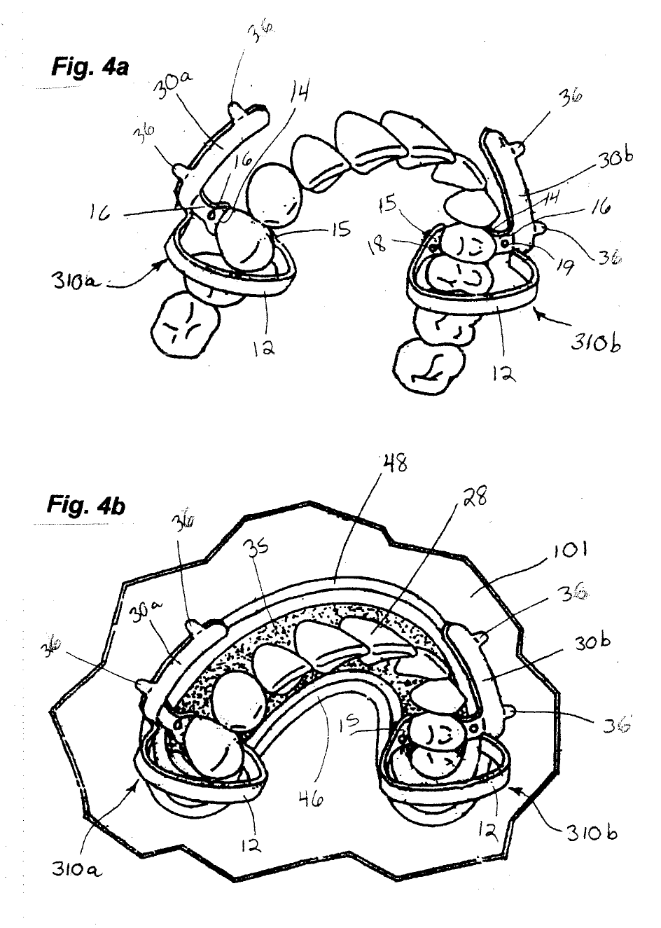

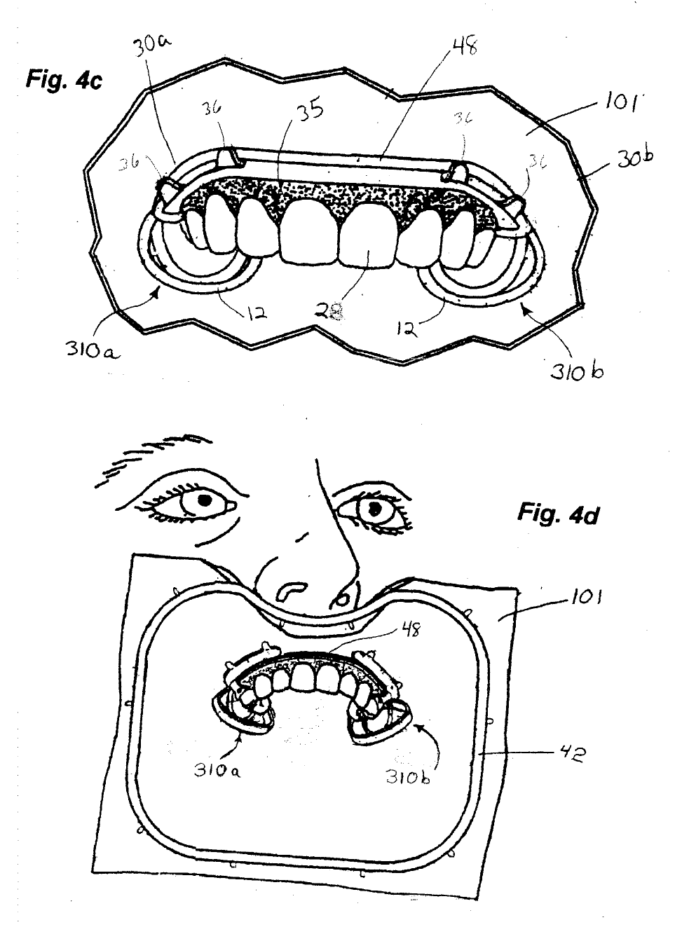

FIGS. 4a, 4b, 4c, and 4d illustrate a pair of left, 310a, and right, 310b, anterior field isolation rubber dam clamps which cervically retract an anterior field isolation rubber dam, 101, below the gum line, 34, thus exposing both the anterior teeth, 28, and their associated soft tissues, (gums) 35 simultaneously while giving stability to the anterior field isolation rubber dam, 101. The general field isolation dam 101 depicted in 4b, 4c, and 4d transmit cervically directed forces to the labial bow operative insert 48 located around the perimeter of the operating site to lend stability to the labial bow. The anterior cervical retraction clamps have a transverse arch spring member, 12, as in the posterior clamps, and labial retraction extensions, 30a and 30b. These anterior retraction clamps may alternatively have both a labial retraction and also lingual retraction extensions, but this embodiment is not shown in the illustrations. Located on the labial retraction extensions, 30a, 30b, are four rubber dam attachment nibs, 36, which attach the rubber dam to the clamps and allow for variable retraction of the operative perimeter of the rubber dam membrane. As on the posterior clamps, these anterior clamps are held in place by reciprocal clasps 14, 15; one contacting the labial surface of a tooth 14, and an opposing clasp for the lingual surface of the tooth 15. The embodiment shown in the illustrations, the labial clasps, 14, are connected to the body of the clamp by an arched connecting member, 16, while the lingual clasps, 15, are more directly connected to the lingual end of the transverse arch spring member, 12. Forceps engaging holes, 16, 18 are located on the labial and lingual clasps respectively. The lingual bow, 46, of the operative insert of the field isolation dam 101 is similarly restrained by the action of the lingual clasping mechanism, 15. Since the rubber dam material does not constrict around individual anterior teeth in the field isolation rubber dam, some retention and support of the dam is lost in this type of application. Cervical retraction rubber dam clamps, through their labial cervical retraction elements, 30a and 30b, counteract this lost retention of the dam anteriorly and oppose the forces generated by the retraction of the patient's lips. The two cervical retraction clamps contacting the labial bow of the operative insert 48 which spans the distance between the field isolation rubber dam clamps, completes a full labial retentive mechanism of the anterior field isolation dam. FIG. 3d shows the completed application, with a general field isolation rubber dam, 101, isolating an anterior segment of teeth, 28, and associated soft tissues (gums), 35. The outer perimeter of the dam is stretched over a frame, 42, external to the patient's mouth.

Cervical Retraction Rubber Dam Clamps With Added Elements

General field isolation rubber dam clamps may have added interactive elements to improve and complete retention, retraction and support of either isolation with the slit-dam technique or with specially designed field isolation rubber dams. In general, these added elements may be either malleable, resilient and deformable, or substantially rigid in nature. It cannot be ruled out that some elastic elements might be also applied in field isolation techniques, although most of the discussion of added elements will focus on the three classifications of elements specified. An embodiment which employs a mesh element for the micro-mechanical attachment of barrier adhesives is discussed, and also an embodiment where the operative insert of a field isolation rubber dam is designed to be directly attached to a cervical retraction clamp as an extended element is also disclosed.

Anterior Isolation Clamps With Extended Elements:

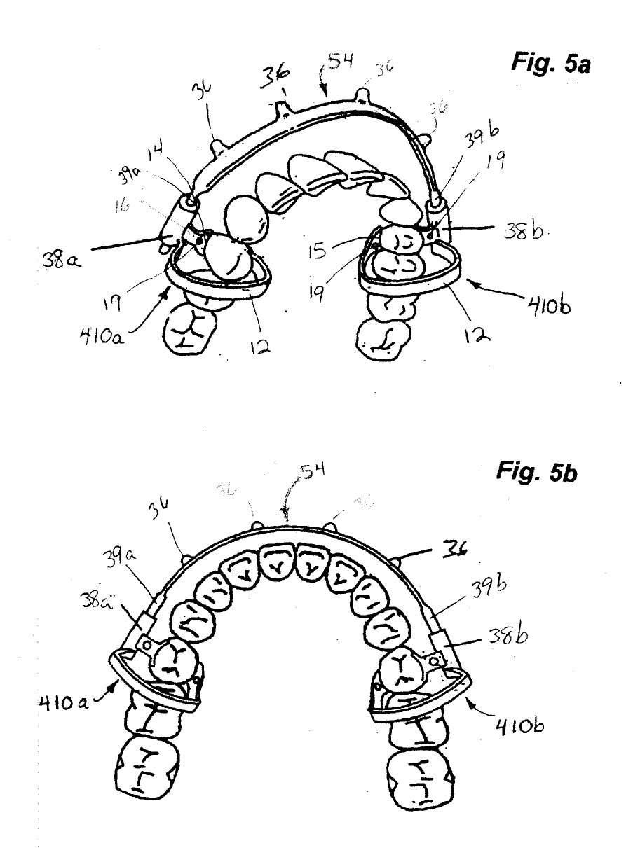

Since there is a wide spectrum of curvature of the alveolar arch in the human dentition, it is unfeasible to attempt to design a field isolation retention appliance without the ability to adapt to multiple arch configurations and widths. FIGS. 5a and 5b show a resilient or malleable labial bow element 54 which may be flexed or individually configured to different arch curvatures by the clinician. In addition to malleable or resilient labial bow elements, an element which is substantially rigid, but retains some flexure within the elastic limit of its material composition, may be a candidate for serving as an intervening element used in conjunction with field isolation rubber dam clamps. This labial bow element 54 connects to left and right field isolation rubber dam clamps 410a and 410b specially designed for attachment of the intervening element. On each end of the labial bow element 54 is a cylindrical end attachment 39a and 39b respectively which insert into a corresponding cylindrical bore on the connecting elements 38a and 38b located on the left and right clamps 410a and 4120b. FIG. 5a and FIG. 5b illustrate that the anterior labial bow retraction element 54 has four rubber dam attachment nibs, 36 spaced equidistantly across the span of the element. These rubber dam attachment nibs attach the rubber dam membrane to the anterior element and allow for variable retraction of the rubber dam around the perimeter of an anterior operating site. The cervical retraction clamps have many of the same elements as the clamps without extended elements, such as a transverse arch spring member, 12, labial clasp, 14, attached to the body of the clamp by an arched labial connector 16, a lingual clasp, 15, and forceps engaging holes, 19. The major difference between these clamps and the clamps without extended elements, however, are connecting elements, 38a and 38b located respectively on the left and the right clamps and the fact that the clamps connect to an extended element. The type of cylindrical shaft/cylindrical bore attachment shown provides an illustration of one type of connecting element only. Other types of connectors would serve just as well, such as a slotted recess/rectilinear element, a pivoting axis type of connector, a cylindrical snap-fit connector, or other unmentioned connectors. Alternative connectors not mentioned are relatively inconsequential to the overall concept of design and should be considered within the spirit and scope of this disclosure. Although the labial bow extended element retainer may be used to retract a specially designed anterior field isolation rubber dam, this design may be especially efficacious in retracting a dam prepared with individual holes for conventional isolation, or both holes and a slit in the hybrid application. The individual rubber dam attachment nibs allow for variable retraction of the rubber dam membrane in a cervical direction in order to expose the anterior teeth, gum line, and gingival tissues for anterior cosmetic procedures, such as porcelain laminates or indirect bonded restorations.

Alternatively, circumferential anterior extended element forms which may be connected to cervical retraction rubber dam clamps of analogous design for anterior retraction of a rubber dam requiring both an intervening labial bow and a lingual bow for simultaneous retraction in an anterior application. The design of whole circumferential perimeter extended elements creates a retractive mechanism all the way around the perimeter of the proposed operative site. This type of extended elements have four elements in their construction; a facial bow (also called a labial bow) lingual bow, and bilateral transverse arches which link both ends rigidly into a contiguous retraction periphery. Malleable or resilient devices may be easily individualized by the clinician by being formed or flexed to arch curvatures required. Rigid elements manufactured in different sizes and shapes to approximate individual requirements of arch form and manufactured of plastic which is somewhat resilient within the elastic limits of its material composition to compensate for variations of arch form may also be fabricated.

Posterior Isolation Clamps With Extended Elements:

The design of posterior isolation clamps with attached extended elements may also fall into three general categories of material composition: malleable, resilient and deformable, and rigid. The design of posterior extended elements may be of an open ended design, analogous to the open ended cervical retraction clamp without extended elements, or alternatively may be a whole circumferential perimeter with the four elements of a facial bow (buccal bow in the posterior region), a lingual bow, and posterior and anterior transverse arches linking the facial and lingual bows. The malleable and resilient and deformable elements will be customizable by the clinician as an end-user, while the rigid elements made of plastic or composite, will have some compensatory mechanism of resilience within the elastic limits of their material composition. These posterior elements, as with the anterior extended elements, may be manufactured in various sizes and alternative forms to accommodate the segment of arch be isolated, and anatomical variations of arch dimensions and curvatures.

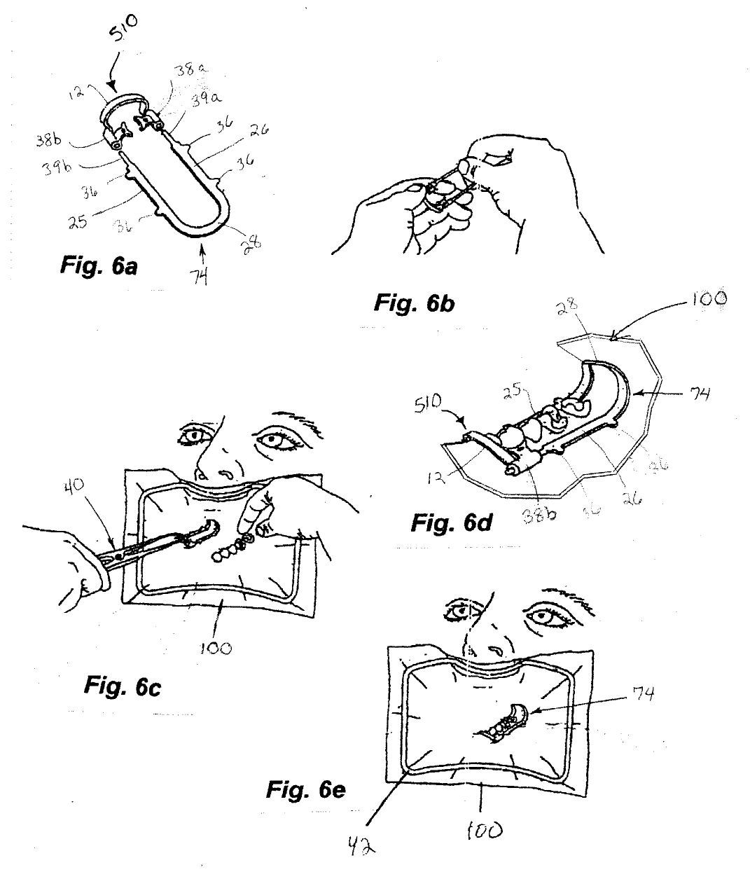

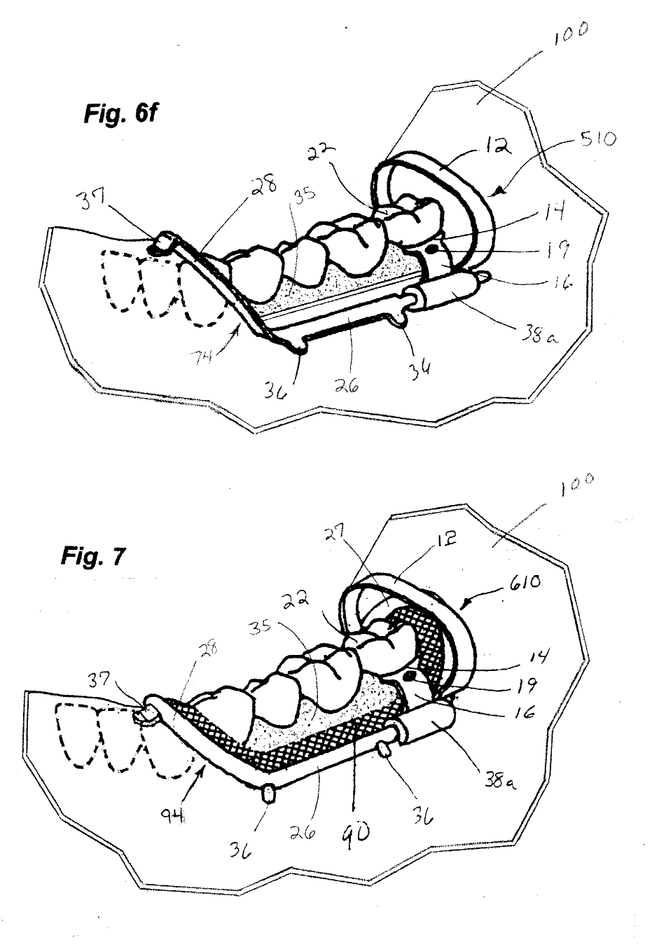

FIG. 6a through 6f illustrate a posterior cervical retraction clamp 510 with a malleable posterior intra-arch extended element 74 and the method of bending the device to customize it to an individual anatomic application. FIGS. 6a through 6e show the clamp and extended element applied in a reverse orientation in order to retract a rubber dam membrane in a posterior area of an alveolar arch where disease has compromised teeth to the degree that there isn't a clinically intact molar tooth to directly clamp. In this application the retentive clamp is placed anteriorly with the extended element cantilevered and facing posteriorly. FIG. 6a shows the posterior cervical retraction clamp 510, with bilateral connectors, 38a and 38b, which connect to the malleable extended element, 74. Around the periphery of the extended element are rubber dam attachment nibs, 36, to allow for variable retraction of the rubber dam from the operative site. In FIG. 6b the malleable extended element is attached to the clamp and the end is bent with finger pressure to form a posterior transverse arch and facial and lingual bows. In FIG. 6c, the clinician is shown placing the clamp/extended element over the arch to be applied in a reverse orientation with a rubber dam forceps 40. FIG. 6d shows the device in reverse orientation retracting the rubber dam over the operative site. FIG. 6e shows the complete application, with the rubber dam membrane, 100, stretched over a frame, 42, exterior to the patient's mouth. FIG. 6f shows the same clamp and extended element in a forward orientation, isolating teeth in a posterior segment which have intact clinical crowns.

Adhesively Retained Cervical Retraction Clamps

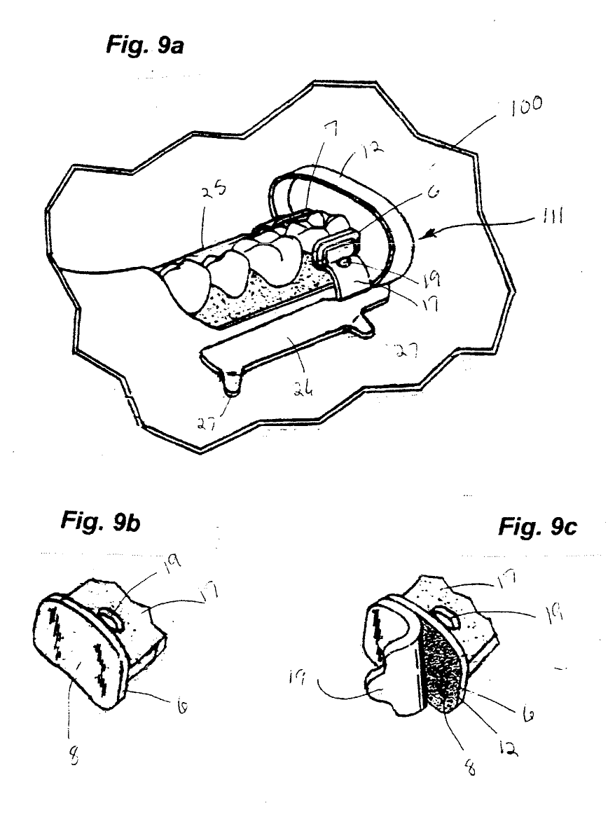

Although all of the illustrations of cervical retraction rubber dam clamps of this disclosure describe the predominant prior art method of attaching rubber dam clamps with spring-activated mechanically retained clasping mechanisms, any or all of the clamps of this disclosure may alternatively be retained by alternative means utilizing broad-based elastomeric retention pads with or without adhesives supplementing their retention. FIG. 9a shows a posterior cervical retraction clamp with broad-based adhesive pads 6, 7 contacting the tooth reciprocally on both sides. These elastomeric pads are connected to the body of the clamp with arched connecting members, 16, 17 in the same manner in which their mechanical clasping counterparts are connected. FIG. 9b shows a broad-based connecting pad, 6 with its contacting surface 8 which applies improved frictional forces reciprocally to a tooth or alternatively serves as a platform upon which to add manually applied adhesives. FIG. 9c shows a broad-based connecting pad, 6 with a pressure-sensitive adhesive 12 applied to its contacting surface 8, and a release liner 19 partially peeled back to show the tacky adhesive surface beneath the liner.

Extended Elements Fabricated With a Mesh Attachment Mechanism

FIG. 7 shows a posterior cervical retraction clamp, 610, attached to a specialized extended element 94 which has a fabric or mesh, 90, which allows an unpolymerized barrier adhesive to be applied to the mesh to micro-mechanically bond the barrier material to the extended element after polymerization is complete. The clamp 610 is analogous to previously described clamps, with a posterior transverse arch spring member, 12, opposing clasps, 14, 15, attached to arched connectors, 16, 17, with forceps engaging holes, 19 located in each of the arched connector elements. The type of connectors depicted, 38a and 38b are a ‘snap-fit’ connecting mechanism. Although a posterior extended element with a mesh material is illustrated, anterior extended elements with this configuration are alternative embodiments of this type of extended element. On the outer periphery of the mesh extended element 94 are at least four rubber dam attachment nibs, 36, and on the anterior transverse arch, 28, is located a rubber dam retraction tab, 37 which functions in a similar manner to the nibs.

Extended Elements Fabricated Within a Rubber Dam Membrane

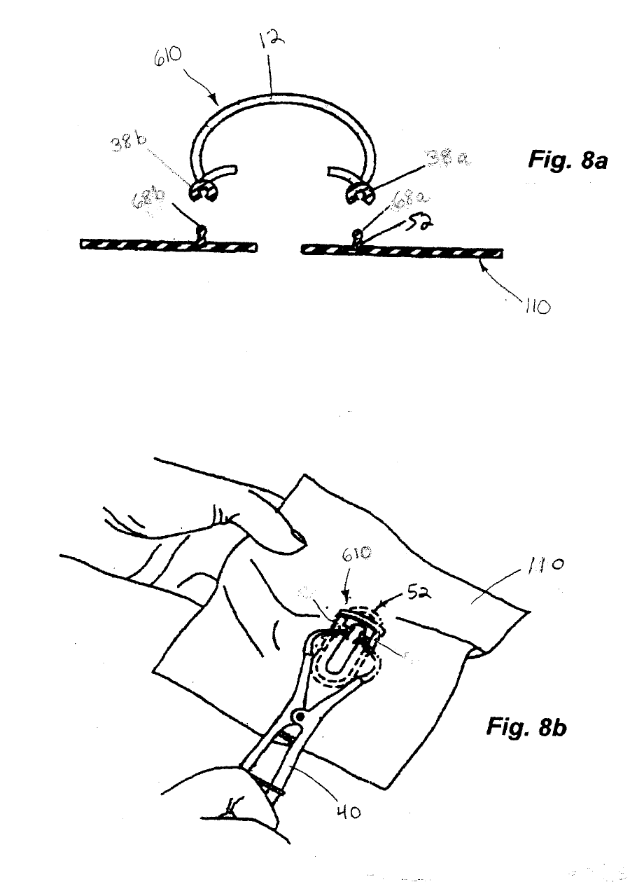

FIGS. 8a and 8b show an alternative embodiment; a specialized design of an extended element 52 which is an operative insert imbedded within a rubber dam membrane 110. The operative insert 52 directly connects to a cervical retraction rubber dam clamp 610 with connecting elements 38a and 38b which engage projecting elements 68a and 68b which are projections of the operative insert 52 imbedded within a rubber dam membrane. In this specialized case, the specially designed rubber dam which directly attaches to the clamp becomes a type of extended element of the clamp within the context of this disclosure. The type of specialized connectors shown are on the clamp 610 are semi-circular ‘snap-fit’ connectors 38a and 38b which engage the specialized projections, 68a and 68b. FIG. 8b shows a clinician placing the field isolation rubber dam, 110, and attached clamp, 610 with a rubber dam forceps, 40 spreading the clamp for an application of the rubber dam clinically. Although a posterior application is depicted, anterior embodiments are equally within the spirit and scope of this disclosure. While the disclosure describes one type of connector only, other types of connectors would serve just as well and should be considered to be within the spirit and scope of this disclosure.

Inter-Arch Retraction and Retention Devices

Inter-arch retraction and retention devices may be of malleable, resilient, or rigid composition. If the device is fabricated primarily of a resilient material, or of a rigid material with some properties of resilience within its elastic limit, the device may be retentive alone without the use of clamps, or alternatively may be used as an extended element in conjunction with the clamping devices connected to the inter-arch element. If the inter-arch element is of a malleable composition, clamps will generally be required to complete the retention of the retainer for rubber dam retraction. Although most of the discussion will cover the resilient elements, the principles of retention and retraction of these elements, regardless of the composition is the same, subject only to the qualifications of application stated above.

Posterior Unilateral Resilient Inter-Arch Retraction and Retention Devices

The posterior resilient and deformable or rigid retraction and retention devices are generally unilateral in nature. These devices are inter-arch retraction devices, stabilized in place and deriving their forces of retraction from the reciprocal forces of the patient's musculature, transmitted between the maxillary and mandibular alveolar arches. The design features of reciprocal retention and cervical retraction act to expose both the patient's dentition and associated alveolar soft tissues for subgingival instrumentation in an appliance which is easily placed in position and is comfortable to the patient. The reciprocal inter-arch forces generated by the appliance upon partial closure and interaction with the patient's alveolar arches not only provides retention of the device, but provides an added benefit, in that a gentle action of propping the mouth open during clinical treatment is achieved. FIG. 10a through 10h show a posterior inter-arch retaining device 176. The elements of reciprocally opposing anterior transverse arches 28a and 28b, reciprocally opposing facial bows 29a and 29b, reciprocally opposing lingual bows 31a and 31b, reciprocally opposing posterior transverse arches 38a and 38b, are connected by the intervening inter-occiusal linking elements 30a and 30b. Rubber dam attachment nibs, 27 are dispersed around the entire periphery of the retaining device. FIGS. 10b and 10d show all of these elements and also the upper lingual bow 31 a and lower lingual bow 31b. FIG. 10b shows the posterior retraction element 176 retracting a field isolation rubber dam, while FIG. 10e shows the same posterior retraction element 176 retracting a conventional isolation rubber dam 100. FIG. 10c shows a resilient posterior inter-arch retraction device 176 being bent with a pair of bending pliers 51. FIG. 10f shows the completed rubber dam application with an exterior frame 42 retracting the outer borders of the rubber dam membrane 100. Either a conventional rubber dam membrane or alternatively a general field isolation rubber dam membrane may be stretched over the retention device, depending on whatever type of clinical isolation is required. FIG. 10g shows a posterior inter-arch retraction device 176 being supplemented with an upper and lower cervical retraction rubber dam clamp 610 designed to connect to the retracting element 176 with a ‘snap fit’ connector. FIG. 10h shows the completed rubber dam application. Although not shown, posterior unilateral inter-arch retention devices may be curved to follow arch curvature so that the anterior transverse arches are located at the patient's midline so as to isolate an entire quadrant of teeth, as opposed to the straight embodiment shown which isolates only a posterior segment of teeth.

Malleable Inter-Arch Retaining Devices

The malleable inter-arch retaining devices 176 are constructed within the same elements of form of the resilient unilateral inter-arch devices, except they are made of a malleable, non-resilient material and require rubber dam clamps to hold them in place. The malleable elements are subject to the same parameters of the material handling characteristics of the malleable inter-arch devices. Since these inter-arch retention devises connect directly to the rubber dam clamps previously described, these inter-arch elements are considered to be extended elements of the clamping devices previously described, in much the same way in which the intra-arch extended elements work in connection with the clamps. FIG. 10g shows a unilateral posterior inter-arch retaining device 176 connected to upper and lower cervical retraction rubber dam clamps, series 610. This application is considered a hybrid of the use of intra-arch clamping devices with an inter-arch retaining device. Although a malleable inter-arch element is described as functioning in this capacity, a resilient, rigid, or even an elastic inter-arch retention device might connect directly to clamps in an analogous manner as the malleable inter-arch element.

Anterior Resilient Inter-Arch Retraction and Retentive Devices:

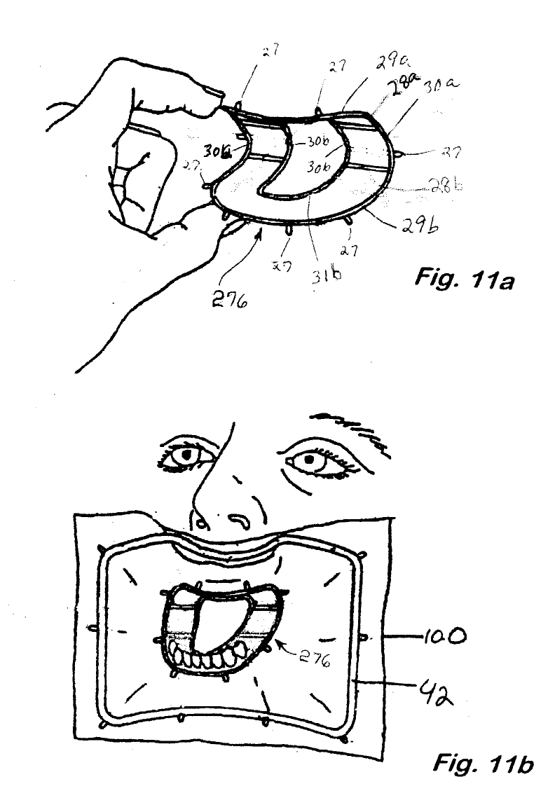

FIG. 11a shows an anterior bilateral resilient retention device 276 which shares all of the same design features of the other intra-arch devices in that retraction of the rubber dam membrane is in a cervical direction, utilizing the reciprocal forces of both arches and the patient's musculature for retention and retraction. The anterior resilient retraction device resists flexure by the application of forces generated by the patient upon partial closure. The reciprocal forces within the resilient device act like a gentle mouth prop, aiding the patient in maintaining the mouth in an open position during clinical treatment. The anterior retraction appliances are bilateral in nature, distributing the patient's forces of closure in a balanced and comfortable manner during treatment. The rubber dam is retained in the mouth by reciprocal inter-arch forces instead of with rubber dam clamps. FIG. 11a shows the elements of construction of this type of device. Shown are the reciprocal labial bows, 29a and 29b, the reciprocal lingual bows, 31a and 31b, bilateral inter-occlusal linking elements, 30a and 30b. Intervening between the reciprocally opposing labial/lingual bows and the inter-occlusal linking elements are the reciprocally opposing posterior transverse arches, 28a and 28b. Ten rubber dam attachment nibs, 27 radiating outwardly from the outer periphery of the labial bows 29a and 29b and inter-occlusal linking elements 30a. Either a conventional rubber dam membrane or a general field isolation rubber dam membrane may be stretched over the bilateral inter-arch retention device for whatever type of isolation the clinician desires. When a rubber dam membrane is reciprocally stretched over all of the attachment nibs, the retention device is linked to the rubber dam membrane. The membrane can then be either prepared for field isolation with a slit or conventional isolation with individual holes punched. The dam and the retention device are then flexed into a generally rounded “U” shape and the patient is instructed to close down on the retention device with slight pressure. Reciprocal forces holds the dam and the retention device in the mouth and the device functions as a mouth prop and a mouth rest for the patient to comfortably keep his/her mouth open during treatment. Although not necessary in most circumstances, supplementary rubber dam clamps may be added at the discretion of the clinician. With the retention device retaining the dam, the periphery of the rubber dam membrane is stretched over a framework 42 external to the patient's mouth as shown in FIG. 11b. Anterior inter-arch retention devices may be designed to isolate teeth in the anterior segment or as far posterior as the anterior half of an arch, before the isolation device begins to encroach upon the intra-alveolar space where the patient's tongue is accommodated. If rubber dam material encroaches upon this space, the patient will gag and otherwise reject the appliance.

The Anterior Resilient Inter-Arch Retaining Device With an Integral Peripheral Frame

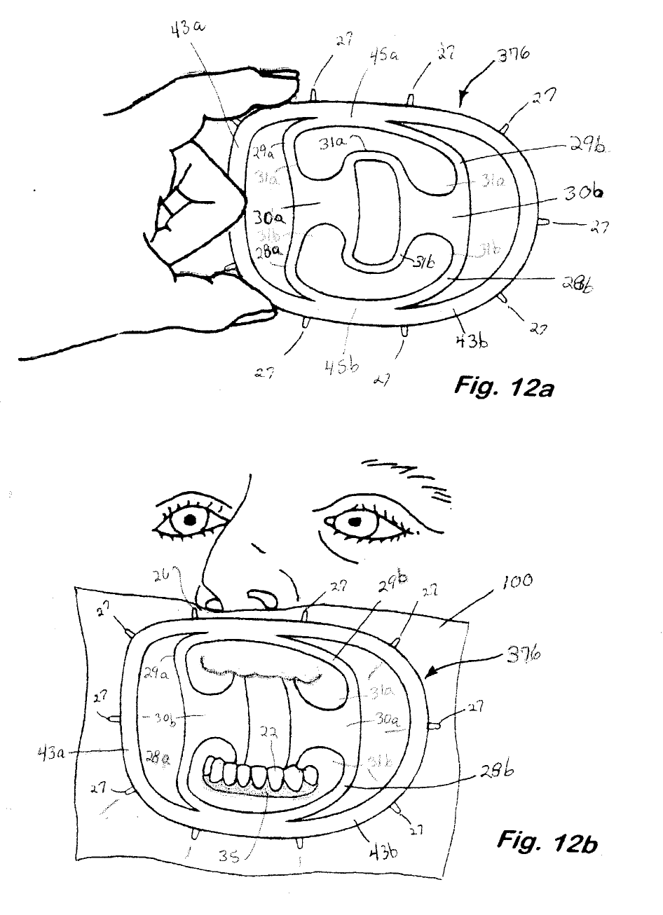

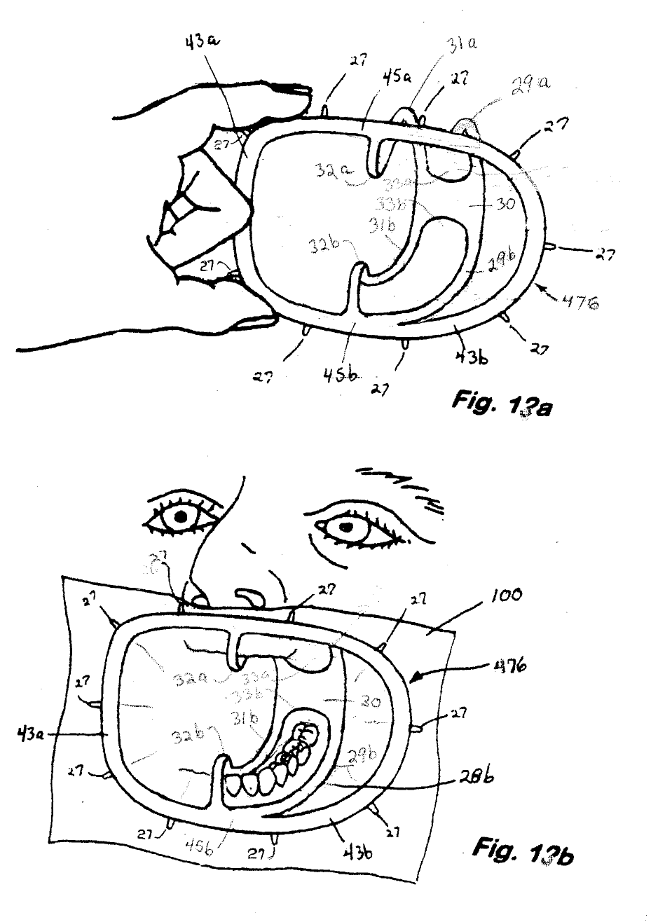

The previous discussion of the anterior bilateral resilient inter-arch retention device focused on all of the elements of construction of this type of device only, since the embodiment shown in FIGS. 11a and 11b retracted a rubber dam membrane which was stretched over an external framework which was a device which was separate from the inter-arch retention device and the rubber dam membrane. Another embodiment of this type of inter-arch retention device combines all of the elements of the embodiment shown in FIGS. 11a and 11b, but with an integrally attached external resilient framework. FIG. 12a shows an embodiment of an anterior resilient inter-arch retaining device with an integral framework 376. In this embodiment, an integral frame composed of a left and right side 43a and 43b form a circumferential frame attached to the inter-arch retention device at the upper and lower midline of the device 45a and 45b. The elements of the inter-arch retention devices are the same: The upper labial bow consists of the left and right sides of the bow 29a and 29b. The lower labial bow consists of the left and right sides of the lower labial bow 29a and 28b. The upper bilateral posterior transverse arches are both labeled 38a the bilateral transverse arches are 38b. The upper lingual bow is represented as 31a and the lower lingual bow 31b. All reciprocally opposing elements are linked by inter-occlusal linking elements, left side 30a and right side 30b. Ten rubber dam attachment nibs 27 radiate outwardly from the outer border of the integral circumferential frame. This device is used in much the same way as the bilateral inter-arch retaining device, except that the rubber dam membrane, after attachment to the device is not stretched to an outer framework which is a separate device because the external framework is already built into the device. Either a conventional rubber dam membrane or a general field isolation rubber dam membrane may be reciprocally stretched over the operative insert and the integral frame, until engaging the ten outwardly radiating rubber dam attachment nibs and attached to the frame. The device is generally flexed into a rounded “U” configuration, which flexes both the retention device and the framework simultaneously. The retention device is inserted into the patient's mouth under flexure and the patient is instructed to partially close on the device until the teeth to be isolated are brought through the dam into the operating site and the opposing teeth rest in a ‘cradle’ of intact membrane between the facial and lingual bows of the opposing side of the device. (The exterior framework stays outside of the patient's mouth). The device is retained by reciprocal force of the patient's upper and lower arches and forms a mouth rest for the patient to rest their mouth while treatment is underway. Although not necessary in most circumstances, supplementary rubber dam clamps may be added at the discretion of the clinician. Although graphically depicted in FIG. 12a and FIG. 12b is a retaining device which is flat and then bent and/or flexed into its functional configuration, this same type of retention device can be slightly modified to be manufactured as a three-dimensional bilateral inter-arch retention device. This slight change in embodiment would allow the operative insert to insert more posteriorly into the oral cavity, allowing isolation of teeth past the anterior segment. Of course, this three dimensionality has limits. Any retention device carrying rubber dam material past approximately the anterior half of the arch must take into account the intra-alveolar space or lingual space medial to the alveolar arches where the patient's tongue is accommodated in order to prevent the patient from gagging and rejecting the isolation device.

The Posterior Resilient Inter-Arch Retaining Device With an Integral Frame

In a similar manner in which the anterior resilient inter-arch retaining device with an integrally attached frame is described, another embodiment of these devices is the posterior resilient inter-arch retaining device with an integrally attached external framework 476. This embodiment is shown in graphic detail in FIGS. 13a and 13b. This device is essentially composed of a unilateral resilient inter-arch operative insert with an integrally connected circular or oval resilient framework. Shown in FIG. 13a, the features of this device include all of the elements of a unilateral resilient inter-arch operative insert, including upper and lower anterior transverse arches 32a and 32b, an upper and lower facial bow 29a and 29b, an upper and lower lingual bow 31a and 31b, an upper and lower posterior transverse arches 38a and 38b attached to an inter-occlusal linking element 30 which compensates for the height of the patient's opened mouth. This design shows that a unilateral inter-arch operative insert may follow the full curvature of half of an arch to the midline in order to isolate a full quadrant, unlike the depiction of FIG. 10b, which shows only a straight insert which essentially isolates only a posterior segment. Integrally attached to the unilateral inter-arch insert at roughly the upper midline 45a and lower midline 45b is a circumferential resilient frame, the left half of the frame being numbered 43a and the right side of the frame being numbered 43b. Radiating outwardly all around the frame are ten rubber dam attachment nibs, 27. A rubber dam membrane, which may be a conventional membrane or a general field isolation membrane, is stretched over the operative insert and the rubber dam attachment nibs on the frame until the rubber membrane is held in place by reciprocal forces. The membrane is then prepared for whatever type of isolation is required, and then the device is placed into the mouth of the patient under flexure and the patient is instructed to close partially until the teeth are brought into the operating site and the device aids the patient in resting their mouth in the open position like a mouth prop. FIG. 13b shows the completed application, with a quadrant of teeth brought into the operating site and the opposing teeth cradled in the upper intact membrane between the facial and lingual bows. This device can be oriented so that either an upper or lower quadrant may be isolated for treatment or alternatively, both the upper and lower quadrants on one side of a patient's mouth could be isolated simultaneously. Although not necessary in most cases, supplementary rubber dam clamps may be added at the discretion of the clinician.

Implications of Cervical Retraction Clamps for Conventional Isolation and Hybrid Isolation

Although this disclosure has focused primarily on the value of cervical retraction clamps and retaining devices for general field isolation of both the teeth and associated gingival tissues, these clamps also contribute to clinical applications which require conventional isolation of the clinical crowns of the teeth and also hybrid isolation where some teeth are conventionally isolated while other teeth are field isolated. In conventional isolation, deflection of the rubber dam membrane cervically around an operative site decreases marginal leakage of the dam around the teeth by increasing the surface contact of the dam with the gingival tissues on the tissue surface of the dam. The cervical retraction of the dam below the gum line also increases frictional resistance of the dam with the retaining device, thereby preventing the external tensile stresses of the stretched rubber dam from pulling the rubber membrane away from the ‘necks’ of the teeth, which can create gaps and fluid percolation, breaking the moisture seal. Thus decreased leakage of saliva from beneath the dam provides an operating site which has less. moisture contamination, thereby enhancing adhesive bonding of restorative materials. Alternatively, the anterior labial bow retracting element, with dispersed rubber dam attachment nibs can be of great benefit in retracting a rubber dam which has been prepared for both conventional isolation of some teeth and field isolation of other teeth in a hybrid type of isolation of the anterior segment. This allows the exposure of only some labial sulcuses adjacent to the facial surfaces of select anterior teeth for subgingival instrumentation. In other cases, a clinician may conventionally isolate a quadrant or segment and then later decide that a lesion is more extensive than originally thought to be. By cutting some of the interceptal rubber in order to gain access subgingivally, a hybrid type of isolation results. If cervical retraction clamps are already in place, retraction may be gained without delay, and a procedure which was unanticipated may be undertaken without hesitation. Cervical retraction clamps, for these reasons and others, have application to conventional and hybrid isolation as well as general field isolation.

Material Handling Specifications and Parameters of Malleable Elements

The extended elements of general field isolation retention and retraction devices may be fabricated from wire, or may be metal stampings, die castings, malleable or memory retaining plastic or composite moldings, or other suitable materials with the requisite material handling characteristics and specifications. The cross-sectional shape of the material, the amount of material in cross section, the area moment of inertia, the alloy chosen if it is a metal, with its unique modulus of elasticity, tensile strength, and yield point, and degree of tempering may vary, as long as the handling characteristics and mechanical properties of the element's requirements are satisfied with relation to the ease of bending by the operator and the resistance to deformation by the type and thickness of the stretched polymeric membrane with which it interacts. While the behavioral characteristics of a metal formed into a wire or metal stamping are described for reference, any alternative material or device substituted must impart the following qualities:

The extended element must be quite soft and malleable so as to be easily bendable into any form required by the clinician manipulating it with finger pressure. At precisely the right specifications, the dentist should feel like he is actually molding the element, instead of feeling like he is bending a stiff wire or metal stamping.

Once bent into the configuration required by the anatomical operative site, the material must maintain its configuration with the tenacity of a ‘memory’ of the dentist's specifications and requirements for use, without rebounding to another shape.

It must withstand the tensile forces applied to it by the latex membrane when it is stretched over an external framework and when subjected to the normal stresses of the restrained musculature during an ongoing procedure, such that it does not appreciably distort from the. desired operative shape designated by the clinician who formed it.

Wires of different materials and different gauges were sought out for determination of their handling characteristics in this application. At first, wires of different metals and diameters were chosen from an intuitive basis for qualities of easy bending and handling and also resistance to moderate stresses. Through a process of trial and error four different materials were selected and the appropriate gauges of wire narrowed down to refine the outcome of constructing inserts with appropriate handling characteristics for the application.

Experimental Determination of Element Handling Characteristics

Part I: Plastic Deformation of Malleable Retractive Elements

To test the characteristics of the wires that were considered to be optimal, and also other wires/diameters, the following experiment was conducted:

The wire was bent 180 degrees around a cylindrical object to form a “U” shaped configuration of each wire with a 3/16^{th} inch radius simulating one end of a typical wire loop insert. This partial wire loop was inserted and secured in a vise so that ¾″ of the rounded loop protruded perpendicularly from the vise. To the free end of the loop, a wire hook was placed, with the other end of the hook attached to a strain gauge, accurate to 1/100^{th} of a pound. Initially, the four wires of suitable material composition and diameter were sequentially tested by bending the free end of the wire loop from the flat plane of the partial loop, to a 45 degree angle from the flat plane. This was followed by bending the wire through a 90 degree angle from −45 degrees to +45 degrees. The action was repeated until the test results showed a consistent pattern of repeatable results. The testing measurements from the experiment were as follows:

Wire #1

An annealed copper wire in a 0.040″ diameter was chosen, bent into a continuous loop, and placed into the vise with ¾″ of the loop projecting from the vise. When bent to a 45 degree angle, 1.75-2.00 lbs of pressure was measured on the strain gauge to bend the wire loop for the application.

Wire #2

A 20 Gauge C1008 bright annealed steel wire was also bent into a continuous wire loop and measured for bending with the same ¾″ fulcrum and with the strain gauge. This wire was bent at a 45 degree angle at a reading of 1.75-2.00 lbs of pressure by the strain gauge, duplicating the values in measuring the copper wire.

Wire #3

This was followed by an annealed 0.033 diameter 316 LVM stainless steel wire loop which required 1.64-2.00 lbs. of pressure to bend, again the ideal range.

Wire #4

A number of diameters of aluminum wire were subjected to the same experiment. Aluminum, a very soft and pliable metal, proved to have excellent qualities of plasticity over a range of different diameters. A 0.050″ wire required 1.25-1.50 lbs. of bending pressure, while a 0.064″ wire of the same alloy required 1.75-2.00 lbs. of pressure; both within excellent ranges. Both larger and smaller diameters would be applicable to interaction of the elements with in different clinical applications. Larger diameters up to about 0.070″ might fulfill the handling characteristics required, but the diameter of wire would be quite thick for the application. It should be noted that while wire samples were measured for this application, metal stampings, or die-cast parts or other methods of producing malleable plastic or composite parts would be a suitable replacement for metal elements.

To further refine a range of optimal handling characteristics and to ascertain the parameters of acceptable substitutes for elements a series of numbers was used to rate the handling characteristics of malleable elements for two different metals, aluminum and bare copper wire. A scale of one to 10 was used for the rating scale, with 10 representing the most optimal performance of a wire loop insert for the application, and one representing an outcome that would be undesirable in any circumstance. The degrees of the scale are listed below for more clarification:

| Rating Number | Handling Characteristics |
|---|---|
| 10 | Excellent High Optimal |
| 9 | Near Optimal |
| 8 | Sub Optimal |
| 7 | Acceptable |
| 6 | Useful in many circumstances |
| 5 | Useful in some circumstances |
| 4 | Useful in few circumstances |
| 3 | Undesirable in many applications |
| 2 | Undesirable in most application |
| 1 | Undesirable in any circumstance |

| | | | | | |
|---|---|---|---|---|---|
| | | | | Rating of | |
| Wire | Diameter | Guage | Forces | handling | Character- |
| number | (inches) | (AWG) | in lbs. | characteristics | istics |

ALUMINUM 1100 WIRE LOOPS

| | | | | |
|---|---|---|---|---|
| 1 | 0.0201 | 24 | 0.05 | 1 |
| 2 | 0.0253 | 22 | 0.12 | 2 |
| 3 | 0.0319 | 20 | 0.25 | 3 |
| 4 | 0.0403 | 18 | 0.5 | 6 |
| 5 | 0.0508 | 16 | 1.25-1.50 | 10 |
| 6 | 0.0640 | 14 | 1.75-2.00 | 9 |
| 7 | 0.0808 | 12 | 3.75-4.00 | 3 |
| 8 | 0.1250 | 8 | way too high | 1 |

BARE COPPER WIRE LOOPS

| | | | | |
|---|---|---|---|---|
| 1 | 0.0200 | 24 | 0.25 | 1 |
| 2 | 0.0250 | 22 | 0.5 | 2 |
| 3 | 0.0320 | 20 | 1.00-1.25 | 7 |
| 4 | 0.0400 | 18 | 1.75-2.00 | 10 |
| 5 | 0.0510 | 16 | 2.25-2.50 | 8 |
| 6 | 0.0640 | 14 | 5.50-6.00 | 2 |
| 7 | 0.0800 | 12 | 7.00-8.00 | 1 |

In summary, the material required in this application needs to be in an annealed state or at the most or have a soft temper, if it is a metal. According to the experiments conducted, wire loops of varying material alloys and varying diameters of cross section, bent with a force of from 1.50 Lbs. to an upper limit of 2.50 Lbs. were considered optimal with regard to handling characteristics by the operator and were within an acceptable range of resistance to deformation by tensile forces of the stretched medium thickness (0.008″) latex membrane. While other wires of varying diameters and gauges were tried for this application, many of which might be substituted and achieve somewhat acceptable results, the four wire/diameter combinations were chosen because they approached a range of optimal performance. Wire inserts with a bending force as measured by the aforementioned means with a range of from 2½ Lbs. to 4 Lbs. of bending pressure were also possible candidates. but between 4 Lbs.-6 Lbs. of force as measured by the strain gauge demarked a gradual deterioration of the proper handling characteristics for the application, making the construction of an extended retractive element in this range or above undesurable to bend with finger pressure but still possible to bend with a bending pliers. From a clinical standpoint, any use of an extended element insert above 6 Lbs. of bending pressure would be unacceptable in any malleable element designed for manipulation with finger pressure alone.

While wires were used in the initial production of prototypes to ascertain the optimal handling characteristics and the parameters of performance of the elements, it should be noted that the values obtained may be extrapolated to substitutes for the construction of elements such as metal stampings or die cast parts or other formed parts if the element is of metallic composition, or molded parts is the material is a memory-retaining plastic or composite or other material to be substituted. Any extended element that fulfills the clinical material handling characteristics as specified by this experimentally derived criterion for this application within the parameters defined by these experimental values should be considered to be within the spirit and scope of this disclosure.

Experimental Determination of Retractive Element Characteristics

Part II: Reciprocal Forces in Resilient & Deformable Elements

To test the characteristics of both resilient and deformable retractive elements for optimal characteristics of resiliency and the generation of reciprocal forces, and to determine parameters within which these resilient elements might function successfully, the following experimental protocol was devised:

Resilient retractive elements designed for interaction with general field isolation rubber dams to isolate a quadrant of teeth on one side of the mouth were inserted and secured in a vise in the following manner: one end of the element was inserted 0.750″ into the vice and at a right angle to the face of the vise and secured. The length of the retractive elements tested were all uniformly 4.000″ inches long and 0.750″ wide. They were substantially flat and biased by tempering to remain in a flat configuration. Once secured in the vice, the resilient element was flexed 180 degrees and secured at the free end to a digital measurement strain gauge to measure the amount of reciprocal force generated by flexure to 180 degrees. The testing was repeated on a series of retractive elements until test results showed a consistent pattern of repeatable results. The testing measurements from the experiment were as follows:

In the second phase of ascertaining a range of optimal handling characteristics of clinically useful resilient and deformable retractive elements and to ascertain parameters of acceptable resilient elements for different applications, the experimental values of reciprocal forces which were recorded for the experimental operative inserts placed integrally within general field isolation rubber dams were correlated with clinical trials in which patients judged the handling characteristics of general field isolation rubber dams with resilient operative inserts of varying reciprocal forces by assessing the following criteria:

a. Comfort to the patient upon insertion and removal

b. Fatigue of muscles of mastication causing discomfort over time

c. Adequacy of aiding the patient in maintaining an open mouth

In addition, the requisite handling characteristics of the retractive elements were 10 correlated with results from experiments on resilient and deformable operative inserts which were integrally inserted within field isolation rubber dams in clinical trials in which dentists judged the handling characteristics of general field isolation rubber dams with resilient operative inserts of varying reciprocal forces by assessing the following criteria:

1. Ease of insertion and removal into the oral cavity

2. The dentist's perception of comfort to the patients

3. Adequacy of maintaining the mouth in an open position

4. Adequacy of maintaining the GFI rubber dam in position

The results of determining handling characteristics from both patients and dentists were correlated and the retractive elements and GFI rubber dam inserts rated according to the same rating scale used to evaluate the handling characteristics of the malleable operative inserts. That rating scale was a one to 10 scale with 10 representing the most optimal performance of an insert and one representing an outcome that would be undesirable in any circumstance.

RESILIENT AND DEFORMABLE WIRE LOOPS

| Wire | Values of | Clinical Rating | |
|---|---|---|---|
| loop | Reciprocal Forces | of handling | |
| number | (in lbs.) | characteristics | Characteristics |
| 1 | 0.00 | 4 | malleable/no forces applied |
| 2 | 0.04 | 7 | acceptable |
| 3 | 0.08 | 10 | excellent high optimal |
| 4 | 0.12 | 10 | excellent high optimal |
| 5 | 0.16 | 8 | sub optimal |
| 6 | 0.20 | 6 | useful in short appts. |
| 7 | 0.24 | 5 | useful in short appts. |
| 8 | 0.28 | 4 | useful in short appts. |
| 9 | 0.32 | 4 | useful in short appts. |
| 10 | 0.36 | 4 | useful in short appts. |
| 11 | 0.40 | 3 | short emergency appts. |
| 12 | 0.44 | 3 | short emergency appts. |

The forces required to bend and to permanently deform a resilient retractive element will naturally by higher than the bending of a highly malleable element due to the tempering of the metal insert to produce a memory characteristic. The upper limit of using finger pressure to bend the retractiave elements, as in the analogous case of bending resilient and deformable operative insets insert in field isolation rubber dams, may give way to routine bending with an orthodontic pliers or other bending pliers to form the transverse arches and labial and lingual bows.

Cervical Retraction Clamps and Devices With Integrally Applied Adhesives

1. Pressure Sensitive Adhesives

Cervucal retraction rubber dam clamps with extended elements which have integrally applied adhesuves which adhere directly to oral tissues or to the rubber dam, may have a variety of pressure sensitive adhesives applied to them in their manufacture. Pressure sensitive adhesives, also known as PSAs, are viscoelastic materials, which, in solvent-free form, remain permanently tacky and will adhere instantaneously to a Wide variety of solid surfaces as a result of the application of very slight pressure. A PSA is usually applied in the form of a solvent-free coating on a ‘backing’, in this Application to the extended element of the retraction device. The PSA attaches the Element to a ‘receptor’ (i.e. the surface to which the PSA is to adhere to with the application of pressure—the intraoral mucosa or the enamel of the teeth or directly to the rubber dam).

The PSA must have characteristics which satisfy the requirements of the application intended, in this case of an intraoral retraction and isolation device: a. It must adhere to the receptor, in this case either the enamel of the teeth, the mucosa of the soft tissues, or the rubber dam material with sufficient ‘peel strength’ which resists removal from the receptor; b. it must adhere to these surfaces in the presence of oral fluids present upon application and continue to adhere tenaciously in an environment which is bathed in saliva and water during the course of treatment; c. it must be able to be removed cleanly from the receptor without leaving a residue of adhesive and without causing discomfort, tissue damage, or without rupturing the backing material; and d. it must be hypoallergenic and not irritate the mucosal epithelium upon application or in any manner after application.

It is important that the adhesion to the oral tissues is low enough to allow the adhesive strip to be easily removed by simply peeling off the material using only finger pressure when the extended element is removed at the completion of treatment. The peel force required to remove a strip of material which is typically about ½ cm in width in contact with a tissue surface is from about 10 grams to 15 grams per side of the extended element. A maximum peel force of 50 grams must not be exceeded when applied to the mucosal epithelium in order to avoid tissue damage upon removal.

There are a variety of compositions of mucosal adhesives that would be suitable as integrally pre-applied intraoral adhesives which fulfill these requirements. Suitable limited water solubility polymer adhesives include hydroxy ethyl or propyl cellulose. In addition, polymer adhesives lacking water solubility include: ethyl cellulose and polyox resins. Other possible adhesives suitable for integral application is polyvinyl- pyrrolidone; or still another is a composition of Gantrex and the semisynthetic, water- soluble polymer carboxyrnethyl cellulose. The widely used cyanoacrylates are still another option for consideration. These PSAs can comprise a base polymer alone or in a mixture of base polymer and one or more additives such as plasticizers, tackifiers, fillers, stabilizers, and pigments. This list of PSAs does not exhaust the range of possibilities of alternatives for integrally applied adhesives, and should not serve to limit the options available for this application. Further descriptions of PSAs compatible to this application may be found in the Encyclopedia of Polymer Science and Engineering, (New York, John Wiley & Son, 1988), or the handbook of Pressure-sensitive Adhesive Technology, Ed. Don Satas (New York, Van Nostrand Reinhold Co., Inc. 1982) or A. H. Flanagan, Adhesives Technology Handbook (Park Ridge, N.J., Noyes Publications, 1985(, or many other journals or publications of polymer science.

The integrally applied adhesive substance may be in the form of a viscous liquid, paste, gel, solution, or other suitable form in a substantially uniform continuous coating on the extended element on the side designated for direct contact with the hard or soft tissues or directly in contact with the rubber dam membrane. The adhesive may be covered with a release liner, which is a covering that keeps the adhesive in a maximally tacky state until it is required for use. Upon application, the release liner is stripped off, exposing the adhesive, and applied to the receptor. The release liner may be composed of a single flexible or rigid material or from two overlapping pieces of said material such as a typical adhesive bandage strip design. The release liner is preferably comprised of any material which exhibits less affinity for the adhesive coating than the adhesive substance exhibits for itself, and strips off with finger pressure to expose the adhesive film that it is adhered to. This liner may be comprised of a rigid sheet of material such as polyethylene, paper, polyester, or other material which is coated with a non-stick type of material. The release liner may be coated with Teflon, way, silicone, fluoropolymers, or other non-stick types of materials. Other types of release agents may be found in Kirk-Othmer Encyclopedia of Chemical Technology, 4^{th} Edition, Volume 21, pp. 207-218, incorporated herein as a reference.

2. Adhesives Activated by Chemical or Physical Initiators

Other classifications of tissue adhesives are polymeric compositions which are designed to adhere to hard and/or soft tissues of the human body (fibrin glues or methacrylates are two commonly applied categories, but other compositions may also be substituted), but need an initiator to activate the process of polymerization and adherence to the receptor. Generally, initiators fall into three categories of chemical, thermal, or photopolymerization. Tissue adhesives which are chemically activated may be initiated with chemicals which may be directly applied by the clinician or may naturally found in saliva or tissue composition. Water is a universally available activator; one which may be easily accessed and applied in the course of treatment. Other adhesives may be activated by contact with components of human saliva or even the proteins present on the epithelial surfaces of the gingival or mucosal tissues in the oral cavity. Still other adhesives are designed to be photoactivated by the exposure to light of a certain intensity and wavelength. Tissue adhesives activated by any of these methods are candidates for integral application to the extended elements described in this disclosure.

3. Attachment of Barrier Adhesives to Extended Elements Without Adhesives

An embodiment of the extended elements which have a textile or mesh inner flange for micro-mechanical attachment of manually applied barrier adhesives will allow the clinician to apply unpolymerized viscoelastic materials which will attach to the extended element in order to form an hermetic seal around the periphery of the operative site without the use of adhesives. The extended element, designed to attach to the retentive clamp, will simultaneously allow the attachment of the polymerizable barrier materials by this non-adhesive method and the retracted rubber dam membrane, constricted around the extended element, will form a moisture-proof isolation barrier around the operating site.

With respect to the above described embodiments, it is to be realized that the general relationships of the parts of the invention and illustrative of the function and manner of operation of said invention, and the assembly and use of said invention should be readily apparent and obvious to anyone skilled in the art. Equivalent relationships to those illustrated in the drawings and described in the specifications expressing variations in the size, materials, shape, form, function, and manner of operation, but which describe equivalent relationships to those illustrated in this disclosure are to be considered to be within the spirit and scope of the invention. Further, since numerous modifications and changes will readily occur to those skilled in the art, it is not desired to limit the invention to the exact construction and operation shown and described, and accordingly, all suitable modifications and equivalents may be resorted to by the inventor, as falling within the spirit and scope of the invention. By way of example, although rubber dam attachment nibs are graphically depicted and described in the discussion as the preferred embodiment of attaching a rubber dam membrane to the retention devices, alternative methods of attachment of the rubber dam membrane, such as the use of pressure sensitive adhesives, or other adhesives, or frictional forces of the retention devices may function in an equivalent manner in select circumstances. Another example; although the cervical retraction clamps might preferably be made of tempered stainless steel, due to its resistance to corrosion and resiliency upon heat treating, alternative materials are increasingly being substituted, such as plastics and composites. The malleable extended elements might be constructed of either a highly malleable metal, or alternatively a malleable plastic or composite might be substituted. Variations in clamp design, such as the cervical retraction clamps which attach extended elements, might have an inclination with respect to the clasping mechanism, as opposed to being in parallel alignment but on a more cervically located plane, as depicted graphically. Clamps with connectors in a uniplanar relationship with the connecting clasps which attach to extended elements which are biplanar to achieve the same type of effect of cervical retraction should be considered to be design substitutions which are in the spirit and scope of this disclosure. Similarly, any design substitution with instructions to the end-user to bend the elements in a manner in which equivalency to cervical retraction is achieved, should be considered to be within the spirit and scope of this disclosure. Changes in the sequence of steps of a method of use, or leaving out a step, should not be considered a change in novelty of the invention and should be considered within the spirit and scope of this disclosure.

I claim:

1. Rubber dam retraction and retention devices, comprising a rubber dam membrane in which predominantly cervically directed forces are employed to cervically retract and retain the rubber dam membrane below the gum line in the mouth of a patient during dental treatment.

2. The rubber dam retraction devices of claim 1, further comprising an intra-arch clamp which retracts and retains the rubber dam membrane.

3. The rubber dam retraction devices of claim 1, further comprising an inter-arch cervical retraction device which utilizes the reciprocal forces of the upper and lower arches to retract and restrain the rubber dam membrane.

4. The rubber dam retraction devices of claim 1, wherein the retraction device isolates both the teeth and associated soft tissues in general field isolation applications.

5. The rubber dam retraction devices of claim 1, wherein the retraction device isolates the clinical crowns of the teeth in a conventional rubber dam application.

6. The rubber dam retraction devices of claim 1, wherein the retraction device isolates the clinical crowns of some teeth while selectively isolating other teeth and their associated soft tissues below the level of the gum line.

7. The rubber dam retraction devices of claim 1, wherein the retraction device has a mechanism for the variable retraction of the rubber dam membrane laterally toward or away from the teeth and/or soft tissues.

8. The rubber dam retraction devices of claim 7, wherein the rubber dam membrane may be adjustably retracted laterally by any of mechanical attachment nibs, or by frictional forces, or by adhesive forces in order to eliminate or minimize open gaps or leaks at the tissue-dam interface.

9. The retraction devices of claim 1, wherein the retraction device overcomes the tensile forces of the stretched rubber dam in order to maintain a controlled interface of the rubber dam membrane around the operative site.

10. The retraction devices of claim 2, wherein the rubber dam is retracted cervically from the location of its attachment to a tooth at the level of the gum line.

11. The dam retraction devices of claim 2, further comprising a clamp which utilizes reciprocally directed mechanical clamping forces against the opposing sides of a tooth for attachment to the tooth.

12. The retraction devices of claim 11, wherein the cervical retraction device is a clamp without extended elements.

13. The retraction device of claim 12, wherein the clamps are open-ended clamps, comprising:
a transverse arch resilient spring member;
reciprocally opposing sides linked by the spring member;
reciprocally opposing arched extensions mounted on both sides of the clamp;
reciprocally opposing forceps engaging holes in the arched extensions;
reciprocally opposing clasping mechanisms mounted on the inner ends of the arched extensions; and
a means of attaching a rubber dam membrane to the clamp.

14. The retraction device of claim 13, further comprising one or more retraction arm extensions and means of attaching the rubber dam membrane to the clamp on the retraction extensions.

15. The retraction device of claim 12, wherein the clamps are circumferential clamps comprising:
a posterior transverse arch resilient spring member;
reciprocally opposing sides linked by the spring member;
reciprocally opposing inwardly arched extensions mounted on both sides of the clamp;
reciprocally opposing forceps engaging holes in the arched extensions;
reciprocally opposing clasping mechanisms mounted on the inner ends of the inwardly arched extensions;
a facial arm extension comprising one side of the body of the clamp;
a lingual arm extension comprising a second side of the body of the clamp;
an anterior transverse arch linked to the ends of the facial and lingual arm extensions; and
means of attaching a rubber dam membrane to the clamp dispersed around the periphery of the entire clamp.

16. The rubber dam retraction devices of claim 2, wherein the cervical retraction device is a clamp which attaches an extended element to the clamp, comprising:
a transverse arch resilient spring member, linking;
reciprocally opposing sides of the clamp body;
reciprocally opposing arched extensions mounted on both sides of the clamp body;
reciprocally opposing forceps engaging holes in the arched extensions;
reciprocally opposing clasping mechanisms mounted inwardly on the ends of the arched extensions; and
means of attaching an extended element to the clamp on one or both sides of the body of the clamp.

17. The retraction devices of claim 11, wherein the clamp has inwardly facing broad-based elastomeric pads with or without adhesives added to the contact surfaces as a means of attachment of the clamp to the tooth.

18. The retraction devices of 16, wherein the extended element comprises a single element bilaterally connected to cervical retraction clamps at both ends.

19. The retraction devices of 16, wherein the extended element is incomplete circumferentially, but when connected to a cervical retraction clamp, a complete circumferential perimeter is formed.

20. The retraction devices of 16, wherein the extended element is completely circumferential, with elements of a facial bow, a lingual bow, and opposing transverse arches linking both ends of the facial bow and lingual bow, comprising a complete perimeter.

21. The retraction devices of claim 16, wherein the extended element comprises an inter-arch retention device connected in one or both arches with cervical retraction clamps.

22. The retraction devices of claim 16, wherein the extended element comprises specialized structures for the micro-mechanical retention of a manually applied barrier material.

23. The retraction devices of claim 16, wherein the extended element comprises an integrally applied adhesive to either bond with a manually applied barrier adhesive or alternatively to bond directly to the rubber dam membrane.

24. The retraction devices of claim 16, wherein the extended elements are comprised or material selected from the group consisting of malleable, resilient, and rigid materials.

25. A method of bending and fonning an extended element of a rubber dam retraction device to the required contours of an operative site in order to customize the rubber dam retraction device to an individual patient's anatomical features.

26. The retraction devices of claim 16, wherein extended elements are comprised of a malleable material composition having resistance to bending forces in the range of 0.12 lbs. and 6.00 lbs.

27. The retraction devices of claim 16, wherein the intra-arch elements are bent by the end user into an intact operative perimeter composed of transverse arches, a facial bow, and/or a lingual bow, or are manufactured with these elements of form prior to end-use.

28. The retraction devices of claim 16, wherein the extended element comprises a specially designed operative insert of a rubber dam which directly connects the clamp to the dam, thereby making the dam a type of extended element.

29. The rubber dam retaining device of claim 3, wherein the retaining device primarily utilizes reciprocally opposing cervical forces against the opposing upper and lower alveolar arches to retract the rubber dam cervically below the gum line from a reference point which is the opposing arch of teeth.

30. The inter-arch rubber dam retaining devices of claim 29, wherein the material composition of the retaining device is resilient, or rigid inter-arch elements with characteristics of resilience within the elastic limits of their material composition.

31. The inter-arch rubber dam retaining devices of claim 3, wherein the retaining device comprises a malleable or other composition unable to transmit reciprocal inter-arch forces to retract the rubber dam, but alternatively is linked to cervical retraction rubber dam clamps to retention and retraction of the rubber dam.

32. The retaining devices of claim 3, wherein reciprocal inter-arch forces retain the rubber dam, and wherein the material composition of the inter-arch element is of a material capable of generating reciprocal inter-arch forces.

33. The retaining devices of claim 3, wherein the inter-arch elements are either bent by the end user into an inter-arch retention and retraction device or alternatively manufactured with these elements of form prior to end-use.

34. A unilateral resilient posterior inter-arch rubber dam retaining device, comprising:
reciprocally opposing anterior transverse arches;
reciprocally opposing labial bows;
reciprocally opposing lingual bows;
reciprocally opposing posterior transverse arches;
an intervening inter-occlusal linking element which anticipates the height of the opened mouth and connects all reciprocally opposing elements; and
means of releasably attaching a rubber dam membrane around the outer perimeter of the retaining device.

35. An anterior resilient bilateral inter-arch rubber dam retaining device, comprising:
reciprocally opposing bilateral facial or labial bows;
reciprocally opposing bilateral lingual bows;
reciprocally opposing left and right posterior transverse arches;
an intervening inter-occlusal linking element which anticipates the height of the opened mouth of a patient during dental treatment and connects all reciprocally opposing elements at the location of the posterior transverse arches; and
means of releasably attaching a rubber dam membrane around the outer perimeter of the retaining device.

36. An anterior resilient bilateral inter-arch rubber dam retaining device with an integral frame, comprising:
reciprocally opposing bilateral facial or labial bows elements;
reciprocally opposing bilateral lingual bow elements;
reciprocally opposing bilateral posterior transverse arches;
an intervening inter-occlusal linking element which anticipates the height of the opened mouth of a patient during dental treatment and connects all reciprocally opposing elements at the location of the posterior transverse arches;
a circumferential exterior framework integrally attached to the upper and lower facial bow elements at the midline of the inter-arch retaining device; and
means for releasably attaching a rubber dam membrane to the outer perimeter of the circumferential frame.

37. A unilateral resilient posterior inter-arch rubber dam retaining device with an integral frame, comprising:
reciprocally opposing unilateral facial bow elements;
reciprocally opposing unilateral lingual bow elements;
reciprocally opposing unilateral anterior transverse arches;
reciprocally opposing unilateral posterior transverse arches an intervening inter-occlusal linking element which anticipates the inter-occlusal height of the opened mouth of a patient and connects all reciprocally opposing elements at the location of the unilateral posterior transverse arches;
a circumferential external frame integrally attached to the unilateral rubber dam retaining device at the location of the upper and lower anterior transverse arches at the midline of the device; and
means of releasably attaching a rubber dam membrane to the outer perimeter of the integrally attached circumferential frame.
